(19) United States
(12) Patent Application Publication
(10) Pub. No.: US 2013/0193623 A1
(43) Pub. Date: Aug. 1, 2013

(54) Method and Equipment for Reinforcing a Substance or an Object with Continuous Filaments

(71) Applicant: Sanjay P. Kashikar, Kelmis (BE)

(72) Inventor: Sanjay P. Kashikar, Kelmis (BE)

(73) Assignee: 3B-FIBREGLASS SPRL, Battice (BE)

(21) Appl. No.: 13/641,945

(22) PCT Filed: Apr. 19, 2011
(86) PCT No.: PCT/EP2011/056236

§ 371 Date: Dec. 11, 2012

(30) Foreign Application Priority Data
Apr. 19, 2010 (EP) 10160262.1
Apr. 19, 2010 (EP) 10160270.4

(51) Int. Cl. B29C 70/54

(52) U.S. Cl. CPC B29C 70/543
USPC 264/518; 425/110

(57) ABSTRACT

The present invention provides a method of reinforcing a substance or an object with continuous filaments comprising the steps of (a) supplying a fiber strand from a source of fiber strands, (b) passing said fiber strand horizontally through a passageway (21), (c) subjecting said fiber strand to a fluid such as air flow, within a channel (22) of rectilinear shape having an oblong cross-section, at an angle (γ) substantially perpendicular with respect to the moving direction of the filaments so as to separate said fiber strand into a plurality of smaller strands or individual filaments, and then (d) pulling said separated strands and/or individual filaments horizontally through a divergent zone (23), wherein the area of its exit end (232) is larger than the one of its entrance end (231) and has an oblong cross-section, so as to spread said strands and/or filaments along its diverging wall in a plane. Thus, the present invention proposes an improved frictionless solution to spread the fiber strand at higher speeds with a newly designed and simple apparatus as well as an improved process for reinforcing a substance or an object with continuous filament.

### TECHNICAL FIELD OF THE INVENTION

The present invention relates to an improved process of reinforcing a substance or an object with continuous filaments arranged substantially parallel to each other, in particular a process which comprises the steps of opening and spreading a strand or bundle of fibers into smaller strands and/or individual filaments and arranging them in a plane uniformly using a fluid stream, such as compressed air. The present invention also relates to a spreader assembly and to a process equipment for performance of said improved process. The invention is particularly well suited for, but not limited to, various glass fiber applications, including the production of parts or products consisting of continuous reinforced polymer structures in particular.

### BACKGROUND OF THE INVENTION

Continuous fibers may be used as reinforcement material for a matrix substance such as polymer matrix, said fibers being suitably impregnated therewith. Continuous fibres may further be used to constitute, after impregnation with polymer, the walls of hollow objects such as a cylinder or a reservoir.

Many types of filaments, fibers and strands (collectively “fibers”) can be used as reinforcement material and they are sold as a “roving” in which a plurality of such fibers are collected, compacted, compressed or bound together, by methods known to those skilled in the art in order to maximize the content of roving or to facilitate the manufacturing, handling, transportation, storage and further processing thereof.

In majority of cases, maximum benefit is achieved, when strand or strands of such rovings are “open” or “spread” exposing the exterior surfaces of the individual fibers, so that the individual fibers can be subjected to various treatments, coatings and further processing, for example like infusion, impregnation, penetration, dispersion, spraying etc, in order to make high performance composites.

The mechanical properties of a substance, e.g. polymer matrix, reinforced with continuous fibers can be improved by separating and spreading reinforcing fiber strands into a plurality of smaller strands or individual filaments, and dispersing said strands or filaments uniformly in the substance. Well dispersed fiber composites not only utilize the full performance potential of every individual reinforcement filament, but also provide more consistent product or part quality and performance, as well as aesthetic characteristics.

Continuous fibers are also used for reinforcing, optionally in several layers, the walls of a hollow object, such as a cylinder and a tube, a panel or a container, by being wound around a winding core. By separating and spreading a strand of reinforcing continuous fibers into a plurality of smaller strands or individual filaments, the similar reinforcement effect can be obtained with thinner layers of wound fibers and results in that the reinforced object is lighter than the one reinforced by winding of large strands.

In order to improve the mechanical properties of a reinforced substance with continuous filaments arranged substantially parallel to each other, the present invention provides an improved process for opening a strand (for example, a collection of hundreds or more of individual, small-diameter fibers gathered to form a generally flat ribbon-like flexible bundle) of reinforcing fibers into smaller strands or individual filaments, and spreading the filaments whereby said filaments are arranged in parallel fashion and distributed uniformly across the width of the spread strand.

Numerous methods and devices have been developed for spreading fiber bundles into their constituent filaments or strands. Known methods typically involve vibration, pneumatics, the use of barrel-rollers, or electrostatic charging of the fiber bundle.

U.S. Pat. No. 4,799,985 describes a gas banding jet for spreading fiber tows. The banding jet consists of a gas box into which compressed air or another gas is fed through an adjustable gas metering means. One or more gas exit ports are provided to cause gas from within the gas box to impinge in a generally perpendicular fashion upon the fiber tow that passed across the exit ports. Because a flow channel of the banding jet has a rectilinear shape whose entrance and exit ends have same width, the tow requires to be squeezed and opened by a Godet roll under controlled tension prior to being subjected to the compressed air in order to obtain fibers well spread across the width without wasting compressed air. The whole system requires Godet rolls for controlling the tension to ensure an effective operation.

U.S. Pat. No. 6,032,342 describes a process and apparatus for spreading multiple combined filaments in such a manner that they are orderly disposed in parallel to each other. The multifilament bundle in a flexibly bent condition is subjected to suction air flowing crosswise with regard to the moving direction of the multi-filament bundles. Prior to subjecting the filaments to the suction air flow, the process, however, requires a feeder, such as rolls, for squeezing the fiber bundle so as to softly disengage by a tensile force provided by the feeder the filaments stuck together by a sizing agent. The system requires a feeding control to work effectively. The speed of the process can be hindered or limited by the suction part of the process. Furthermore, the equipment requires an arrangement that allows suction air to go through between the individual filaments perpendicularly to the filament movement and letting the filaments bend in the direction of the suction air flow.

Additionally, the friction and tension created by rollers or bars on the surface of the fiber bundles in order to spread them into individual fibers in a flat arrangement without breakage of fibers permits production only at reduced processing rates. Accordingly, using rolls or bars to separate fiber bundles has limitations, and is not well suited for delicate fibers, particularly when operating at relatively high speeds.

U.S. Pat. No. 3,873,389 describes a process and apparatus for pneumatically spreading thin graphite or other carbon filaments from a tow bundle to form a sheet or tape in which the filaments are maintained in parallel orientation. The process includes a step of passing the tow through a slot venturi of a preblower in which the tow is pulled through the preblower having a venturi in a direction along the primary air flow and subjected to the air flowing in parallel with the moving of the fibers. However such preblower requires for each unit at least a pair of plenum spaces which lie outwardly of and are partially defined by confronting plates. Thus, the stuck array of the single modules becomes much larger-in scale and more complicated in structure. The air stream is applied to the filaments initially along the direction of filament movement but not perpendicularly thereto.

U.K. Pat. Appl. No. 2,340,136 describes an apparatus for a frictionless spread, which has a divergent channel of a fan type shape comprising a pair of closely spaced plates and their peripheries. According this document, a tow is opened with a gas jet system arranged transversely with respect to the tow, prior to spreading the fibers with a fluid flow created within the divergent channel by supplying a viscous fluid at low velocity therethrough. This apparatus, however, can not effectively open and spread a tightly packed fiber strand with the given gas jet system. There is thus a need for a new and improved apparatus that overcomes said problem.

In view of the inconveniences encountered with the prior art for opening and spreading a fiber strand, the present invention proposes an improved and simple apparatus for frictionless spreading of a fiber strand at high speeds as well as an improved process for reinforcing a substance or an object with continuous filament.

### SUMMARY OF THE INVENTION

The subject matter of the present invention is defined in the appended independent claims. Preferred embodiments are defined in the dependent claims.

According to a first aspect, the present invention relates a method of reinforcing a substance or an object with continuous filaments arranged substantially parallel to each other, when delivered to their immediate succeeding processing, comprising the steps of (a) supplying a fiber strand from a source of fiber strands, (b) passing the said fiber strand horizontally through a passageway, (c) subjecting said fiber strand to a fluid flow, such as an air flow, within a channel of rectilinear shape having an oblong cross-section, at an angle substantially perpendicular with respect to the moving direction of the filaments so as to separate said fiber strand into a plurality of smaller strands and/or individual filaments and then (d) pulling said separated strands and/or individual filaments horizontally exiting from a divergent zone, wherein the area of its exit end is larger than the one of its entrance end and has an oblong cross-section, in order to spread said strands and/or filaments along its diverging wall, in a plane arrangement.

Said fiber strand may be subjected to a fluid within the rectilinear channel having a cross-section with an aspect ratio of at least 2:1, preferably at least 3:1, more preferably at least 4:1, even more preferably at least 12:1.

In particular, said separated strands and/or individual filaments are further subjected within the divergent zone to a fluid, at an angle of from 15° to 75°, preferably 20° to 40°, with respect to the moving direction of the filaments. The said fluid may be provided through an oblong intersection of a through hole with said divergent zone.

Preferably, the said fluid may be provided through said intersection having an oblong cross-section with an aspect ratio of at least 4:1, preferably at least 10:1, most preferably at least 30:1.

Advantageously, the said fluid may be provided through said intersection of the through hole with the divergent zone has essentially the same width as the divergent zone.

Preferably, the filaments supplied at step (a) are selected from a group of glass fibers, mineral fibers, carbon fibers, graphite fibers, natural fibers, ceramic fibers, metallic fibers, polymeric and syntethic fibers.

Advantageously, the filaments supplied by step (a) are coated with a sizing or binding agent.

In particular, said method further comprises a step of subjecting the separated and spread strands and/or filaments to a flow of the impregnating matrix substance, and impregnating said strands and/or filaments therewith.

Preferably, said separated and spread filaments are subjected to at least two opposite flows of the impregnating matrix substance, sandwiched and then impregnated therewith.

Advantageously, said opposite flows are in a form of a layer having an oblong cross-section with an aspect ratio of at least 2:1, preferably at least 3:1, more preferably at least 4:1, even more preferably at least 8:1, at the initial meeting point of the strands and/or filaments and the impregnating substance.

Said impregnation substance is preferably applied to said separated and spread strands and/or filaments at an angle of less than 90°, more preferably of from 10° to 80°, even more preferably from 30° to 60°, with respect to the moving direction (A) of the stands and/or filaments.

Preferably, said impregnating substance is supplied in liquid form such as a solution, an emulsion, a suspension or dispersion of said polymer in an aqueous or organic carrier, in molten form or in gel form, inside an impregnation die at any given impregnating temperature.

Advantageously, said impregnating substance is a thermoplastic polymer selected from the group of Polyolefins such as PE, PP and PB, Polyamides such as PA and PPA, Polyimides such as PI and PEI, Polyamide-imide, Polysulphones such as PS and PES, Polyesters such as PET and PBT, Polycarbonates, Polyurethanes, Polyketones such as PK, PEK and PEEK, Polyacrylates, Polystyrene, Polyvinylchloride, ABS, PC/ABS and a-mixtures thereof, or a thermosetting resin precursor selected from the group of Epoxy, Ester, Urethanes, Phenolic, Alkyd and a mixture thereof.

In another embodiment, the method according to the present invention further comprises the step of arranging the strands and/or filaments in a plane after separating and spreading the fiber strands and then winding them up onto a winding core of any shape.

According to another aspect, the present invention concerns a reinforced composite structure obtainable by the method according to the present invention.

According to yet another aspect, the present invention is also concerned with a spreader assembly suitable for separating and spreading a continuous fiber strand into smaller strands and/or into individual filaments and for arranging said strands or filaments in a plane comprising at least one spreader unit comprising (a) at least one passageway having an inlet opening for receiving said fiber strand and an outlet opening through which said fiber strand exits said passageway, (b) an inner channel of rectilinear shape disposed within the passageway, (c) a divergent zone within the passageway having an entrance end connecting to the inner channel and an exit end, and (d) at least one through hole for air flow, connected to the inner channel at an angle substantially perpendicular with respect to the longitudinal direction of the passageway. The intersection of the through hole with the inner channel may consist in one or more holes having smaller dimensions than the said through hole. The area of said exit end of the divergent zone is larger than the one of the entrance end and the divergent zone has an oblong cross-section. The inner channel and the divergent zone are aligned and the inner channel may have a rectangular cross-section with an aspect ratio of at least 2:1, preferably at least 3:1, more preferably at least 4:1, even more preferably at least 12:1.

In particular, said spreader unit further comprises another through hole intersecting with the divergent zone at an angle from 15° to 75°, preferably 30° to 60° with respect to the moving direction of the filaments, and the intersection of said through hole having an oblong shape with the aspect ratio of at least 4:1, preferably at least 10:1, more preferably 30:1, so as to spread the separated filaments along the wall of the divergent zone and arrange the filaments in a plane.

Preferably, said intersection of the through hole with the divergent zone has essentially the same width as the divergent zone.

Advantageously, the through hole connected to the inner channel is located at a point immediately upstream of the entrance end of the divergent zone.

In particular, the divergent zone has a pair of closely spaced walls opposite to each other and sidewalls perpendicular to said opposite walls, wherein the sidewalls diverge outwardly at an angle (a) of from 10° to 50°

The spreader assembly preferably comprises at least two, more preferably at least three, even more preferably at least four spreader units, even more at least six spreader units.

Advantageously, the spreader unit comprises at least two passageways.

According to yet another aspect of the invention, there is provided herewith a process equipment suitable for reinforcing a substance with filaments which comprises the spreader assembly according to the present invention.

According to yet another aspect of the invention, there is provided herewith a use of the spreader assembly according to according to the present invention for separating and spreading at least one fiber strand into a plurality of smaller strands and/or individual filaments.

According to yet another aspect of the invention, there is provided herewith separated and spread fibers obtainable by the use of the spreader assembly according to the present invention.

According to yet another aspect of the invention, there is provided herewith a winding obtainable by winding the separated and spread fibers according to the present invention up onto a winding core.

These and other aspects of the present invention will become clear to those of ordinary skill in the art upon the reading and understanding of the specification.

### BRIEF DESCRIPTION OF THE FIGURES

This invention will be further described in connection with the attached drawing figures showing preferred embodiments of the invention including specific parts and arrangements of parts. It is intended that the drawing included as part of this specification be illustrative of the preferred embodiments of the invention and should in no way be considered as a limitation on the scope of the invention.

FIG. 1 is a side elevation view of a preferred embodiment of the spreader assembly according to the present invention.

FIG. 2 is an elevation view of the outlet opening of the spreader assembly shown in FIG. 1.

FIG. 3 is an elevation view of the inlet opening of the spreader assembly shown in FIG. 1.

FIG. 4 is a plan view of the spreader assembly shown in FIG. 1.

FIG. 5 is a bottom view of the spreader assembly shown in FIG. 1.

FIG. 5a is a perspective view of the spreader assembly shown in FIG. 1.

FIG. 6 is a longitudinal cross-section of the spreader assembly shown in FIG. 1 according to a cutting plane VI-VI of FIG. 4.

FIG. 7 is a cross-section of the bottom part of the spreader assembly shown in FIG. 1 according to a cutting plane VII-VII of FIGS. 1 and 2.

FIG. 8 is a cross-section of the top part of the spreader assembly shown in FIG. 1, according to a cutting plane VIII-VIII of FIGS. 1 and 2.

FIG. 9 is a perspective view of a passageway in the spreader assembly according to the present invention.

FIG. 10 is a cross-section similar to FIG. 7, wherein a bundle of filaments is opening and spreading into individual filaments.

FIG. 11 is a plan view of another preferable embodiment of the spreader assembly according to the present invention.

FIG. 12 is an elevation side view of the spreader assembly shown in FIG. 11.

FIG. 13 is an elevation view illustrating the inlets of the spreader assembly shown in FIG. 11.

FIG. 14 is an elevation view illustrating the outlets of the spreader assembly shown in FIG. 11.

FIG. 15 is an elevation side view of another preferable embodiment of the spreader assembly according to the present invention.

FIG. 16 is an elevation view illustrating the inlets of the spreader assembly shown in FIG. 15.

FIG. 17 is an elevation view illustrating the outlets of the spreader assembly shown in FIGS. 15.

FIG. 18 is a plan view of a spreader unit, which is an external element of the spreader assembly shown in FIG. 15, illustrating two inlets for air

FIG. 19 is a bottom view (cross-section) of the top part of the spreader unit shown in FIG. 15 according to a cutting plane XIX-XIX of FIGS. 15 and 16.

FIG. 20 is a cross-section of the bottom part of the spreader unit shown in FIG. 15, according to a cutting plane XX-XX of FIGS. 15 and 16.

FIG. 21 is a plan view of a spreader unit, which is an inner element of the spreader assembly shown in FIG. 15, illustrating an inlet for air.

FIG. 22 is a bottom view (cross-section) of the top part of the spreader unit shown in FIG. 15, according to a cutting plane XXII-XXII of FIGS. 15 and 16.

FIG. 23 is a cross-section of the bottom part of the spreader unit shown in FIG. 15, according to a cutting plane XXII-XXII of FIGS. 15 and 16.

FIG. 24 is an elevation side view of another preferable embodiment of the spreader assembly according to the present invention.

FIG. 25 is an elevation view illustrating the inlets of the spreader assembly shown in FIG. 24.

FIG. 26 is an elevation view illustrating the outlets of the spreader assembly shown in FIG. 24.

FIG. 27 is a plan view of a spreader unit, which is an external element of the spreader assembly shown in FIG. 24, illustrating four inlets for air.

FIG. 28 is a bottom view of the spreader assembly shown in FIG. 24, illustrating two inlets for air.

FIG. 29 is a bottom view (cross-section) of the top part of the spreader unit shown FIG. 24 according to a cutting plane XXIX-XXIX of FIGS. 24 to 26.

FIG. 30 is a cross-section of the bottom part of the spreader unit shown in FIG. 24, according to a cutting plane XXX-XXX of FIGS. 24 to 26.

FIG. 31 is a plan view of a spreader unit, which is an inner element of the spreader assembly shown in FIG. 24, illustrating two inlets for air.

FIG. 32 is a bottom view (cross-section) of the top part of the spreader unit shown in FIG. 24 according to a cutting plane XXXII-XXXII of FIGS. 24 to 26.

FIG. 33 is a cross-section of the bottom part of the spreader unit shown in FIG. 24, according to a cutting plane XXXIII-XXXIII of FIGS. 24 to 26.

FIG. 34 is a plan view of a spreader unit positioned at the bottom of the spreader assembly shown in FIG. 24.

FIG. 35 is a bottom view (cross-section) of the top part of the spreader unit shown in FIG. 24, according to a cutting plane XXXV-XXXV of FIGS. 24 to 26.

FIG. 36 is a cross-section of the bottom part of the spreader unit shown in FIG. 24, according to a cutting plane XXXVI-XXXVI of FIGS. 24 to 26.

FIG. 37 is a preferred configuration of the intersections of air through hole with a passageway for the filaments of the spreader assembly according to the present invention.

FIG. 37a is another preferred configuration of the intersections of air through hole with a passageway for the filaments of the spreader assembly according to the present invention.

FIG. 38 is a perspective view of an air passage in a preferred embodiment of spreader assembly according to the present invention.

FIG. 39 is a snap shot of opening and spreading four fiber strands into individual filaments which pass through the spreader assembly comprising four spreader units according to the present invention.

FIG. 40 is a schematic illustration of a preferred embodiment of the process equipment according to the present invention for manufacturing a polymer structure reinforced with continuous fibers, comprising the spreader assembly of present invention.

FIG. 41 is a plan view of another preferred embodiment of the spreader assembly according to the present invention.

FIG. 42 is a bottom view of the spreader assembly shown in FIG. 41.

FIG. 43 is a perspective view of the spreader assembly shown in FIG. 41.

FIG. 44 is a longitudinal cross-section of the spreader assembly shown in FIG. 41, according to a cutting plane XLIV-XLIV of FIG. 41.

FIG. 45 is a cross-section of the bottom part of the spreader assembly shown in FIG. 41, according to a cutting plane XLV-XLV of FIG. 44.

FIG. 46 is a cross-section of the top part of the spreader assembly shown in FIG. 28, according to a cutting plane XLVI-XLVI of FIG. 44.

FIG. 47 is a perspective view of a passageway for the filaments in the spreader assembly according to the present invention.

FIG. 48 is a perspective view of the longitudinal cross-section of the impregnation assembly according to the present invention.

FIG. 49 is a cross-section of the impregnation assembly shown in FIG. 48, according to a cutting plane XLIX-XLIX of FIG. 48.

FIG. 50 is cross-section of the impregnation assembly shown in FIG. 48, according to a cutting plane L-L of FIG. 48.

FIG. 51 is a side view of the impregnation assembly shown in FIG. 48 with the outer die removed wherein multi-filaments are being impregnated with the impregnating substance.

FIG. 52 is a cross-section of the sandwiched multi-filaments with the impregnating substance at initial meeting point of the filaments and the impregnating substance, according to a cutting plane LII-LII of FIG. 51.

FIG. 53 is a cross-section of the impregnated multi-filaments with the impregnating substance, according to a cutting plane LIII-LIII of FIG. 51.

FIG. 54 is a snap shot of opening and spreading a fiber strand into individual filaments which pass through the spreader assembly according to the present invention with a first through hole connecting to the inner channel.

FIG. 55 is a snap shot of opening and spreading a fiber strand into individual filaments which pass through the spreader assembly according to the present invention with a first through hole connected to the inner channel and a second through hole connected to the divergent zone.

FIG. 56 is a SEM microscope image of a cross-section of a reinforced tape obtained with the reinforcement system according to the present invention.

### DETAILED DESCRIPTION OF THE INVENTION

The present invention provides an improved process for reinforcing a substance or an object with continuous filaments arranged substantially parallel to each other, when delivered to their immediate succeeding processing, in particular, which comprises the steps of opening and spreading a fiber strand (for example, a collection of hundreds or more of individual, small-diameter fibers gathered together to form a generally flat ribbon-like flexible bundle) into smaller strands and/or individual filaments and spreading the filaments widely.

In view of the inconveniences encountered with the prior art for producing a spread multifilament bundle, the aim of the present invention is to provide a method and apparatus for efficiently separating a fiber strand into smaller strands and/or individual filaments and spreading the smaller strands and/or the filaments in a parallel arrangement across the with and distributed uniformly.

More specifically, one of the problems of the prior art consists in slow operation speeds. The present invention overcomes the prior art problems by feeding a fiber strand to be spread through a spreader assembly of the invention. The general design of the spreader assembly avoids mechanical frictions and allows for operation at high speed without breakage of fibers. Moreover, the present invention does not essentially require any means or equipment for adjusting the tensions of the strand, in which way it is much simpler, faster and does not lead to broken filaments, fuzz or line interruptions either through strand break or for maintenance. It further offers the flexibility of adjusting the fiber content coupled with the fiber spread width through a compact design.

The term “fiber” as used herein means a filament or a fiber of any material, for example, inorganic, metallic, ceramic, polymeric, or refractory materials such as, but not limited to, carbon, graphite, glass, quartz, polyethylene, poly(paraphenylene terephthalamide), benzoxazole, cellulosic derivatives, silicon carbide, and boron nitride. The terms “strand”, “tow”, “bundle” or “roving” as used herein mean a plurality of individual fibers ranging from dozens to thousands in number, collected, compacted, compressed or bound together by means known to the skilled person in order to maximize the content thereof or to facilitate the manufacturing, handling, transportation, storage or further processing thereof. The terms “rectangular” and “substantially rectangular” as used herein, are to be understood as meaning a generally rectangular shape with possible slight defects, for example, rounded corners, and/or a slight bowing, indentation along at least one side, or opposite side not being exactly parallel to each other.

The present invention is particularly suited for, without being limited to, glass fibers with diameters ranging, for example, from 6 μm to 32 μm for a given tex (g/km) strand. Individual fibers having a variety of cross-sections may be used in accordance with the invention. A bundle of fibers used in accordance with the invention preferably has an oblong cross-section, more preferably, a rectangular cross-section. Fiber strands used in practicing the invention are generally twist free strands.

A sizing or binding agent may be applied to each fiber or some fibers in a strand to be spread so as to facilitate the manufacturing, handling, transportation, storage or further processing thereof, and a use of such fibers is included within the scope of the invention. Such sizing or binding agents may be applied in an amount of more than or equal to 0.01%, preferably from 0.01% to 10%, more preferably from 0.2% to 1.00% by weight of the fiber strand.

A spreader assembly according to the present invention includes at least one spreader unit. Preferably one strand is passed through one spreader unit, but more than one strands to be opened into individual filaments may be passed through one spreader unit. The spreader assembly may include two or more spreader units oriented horizontally and possibly arranged vertically one above the other in order to provide enough amounts of spread smaller strands or individual filaments required for subsequent processing. A suitable configuration of plural spreader units enables to control the amount of fibers required and at the same time to adjust the width of the spread fibers as desired per the process and application requirement.

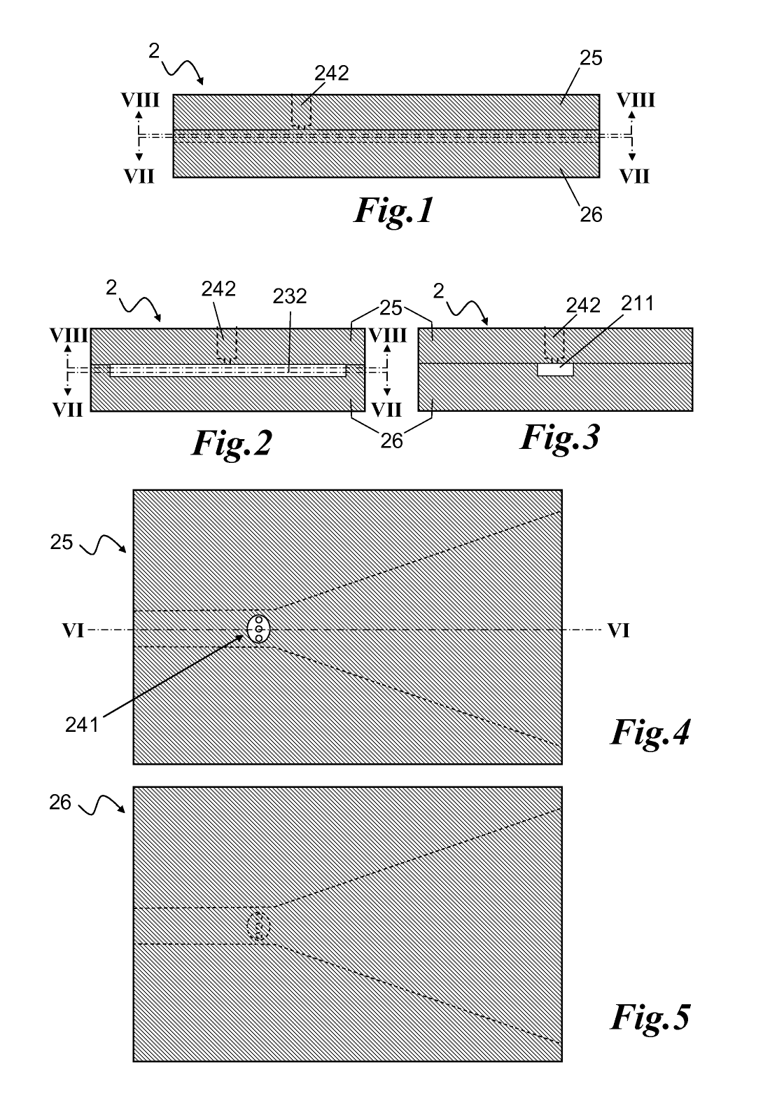

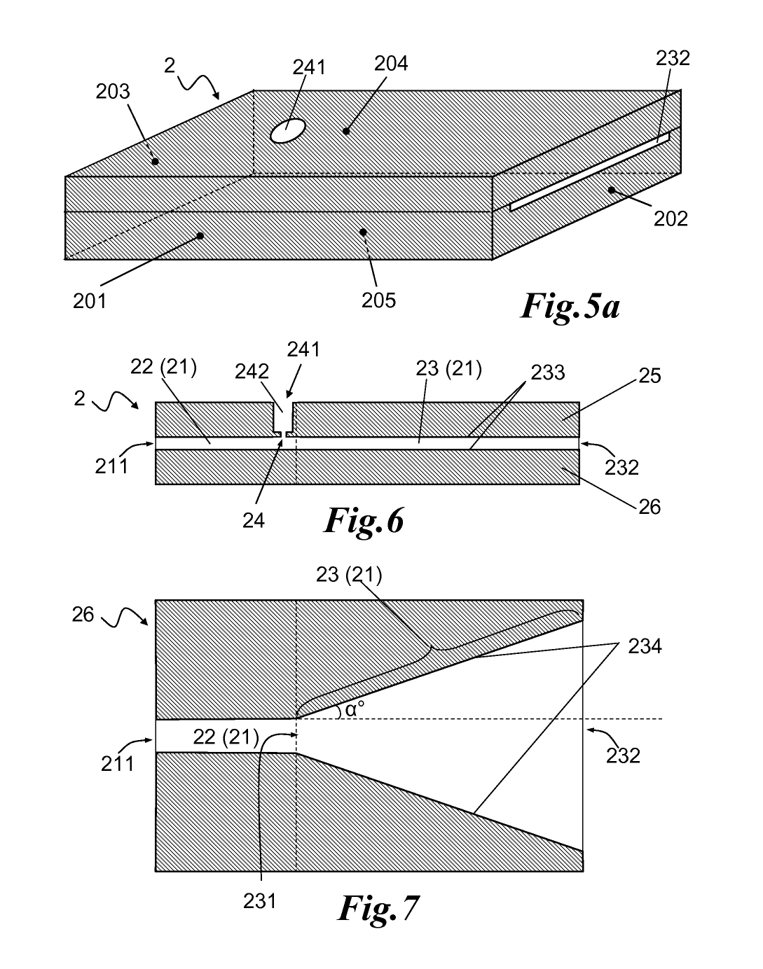

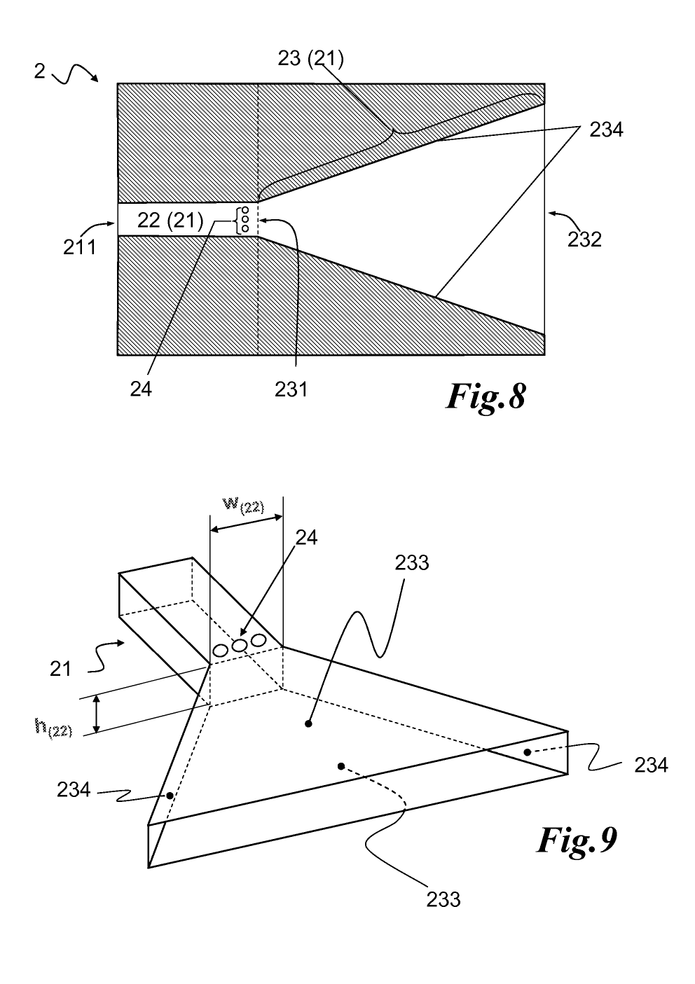

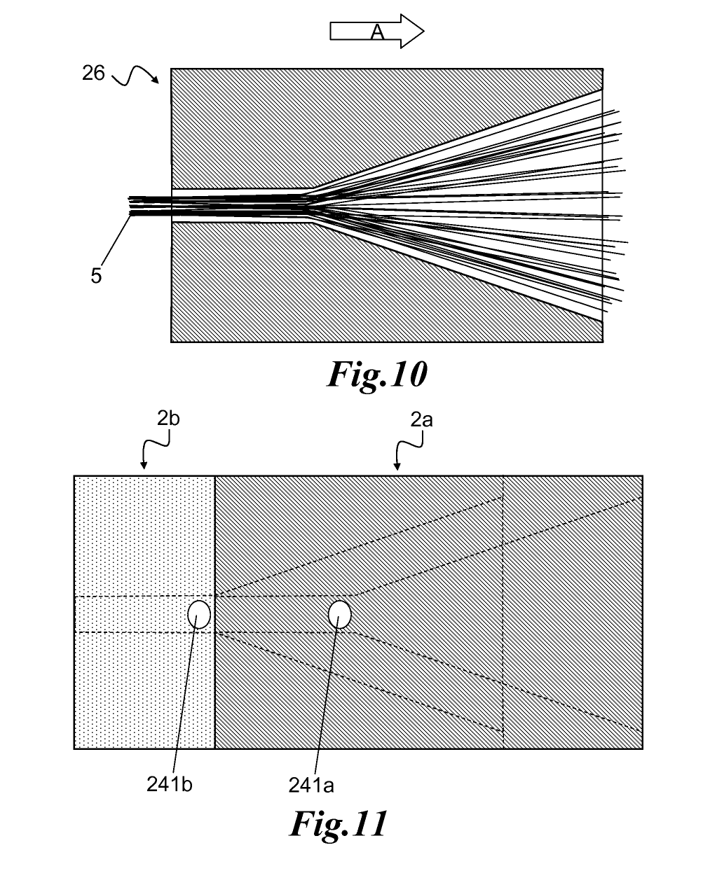

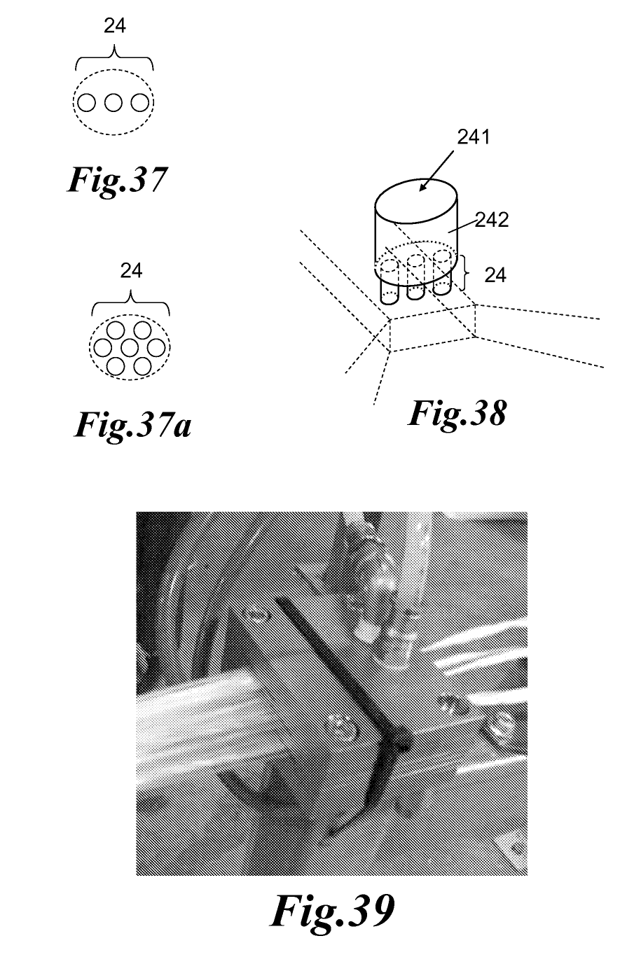

FIGS. 1 to 9 illustrate a preferred embodiment of a spreader assembly 2 according to the present invention. As shown in FIGS. 1 to 3, and 6, the spreader assembly 2 is provided with a cover 25 and a base 26 to be joined together so that a fiber passageway 21 is provided as illustrated in FIG. 9. The spreader assembly comprises two side surfaces 201, a back surface 202, a front surface 203, a top surface 204 and a bottom surface 205 as illustrated in FIG. 5a. The cover 25 is a rectangular plate having a certain thickness and comprises a through hole 242 passing through all thickness of the cover 25 as best shown in FIG. 6. The through hole 242 corresponds to a passage for air as shown in details in FIG. 38. One of the ends of the through hole 242 corresponds to an air inlet 241 as shown in FIG. 4, whish is arranged on the top surface 204 of the cover 25. The opposite end of the through hole 242 corresponds to an air outlet 24 having three small holes which are the intersections between the through hole 242 and the passageway 21 as shown FIGS. 6 and 8. The existence of the plurality of small holes at the intersection increases the ability of the spreader assembly to open a fiber strand which is tightly packed. The number of the small holes is preferably at least two, more preferably three as shown FIG. 37, even more preferably at least seven as shown

FIG. 37a. The bottom surface of the cover 25 forms a top wall for the passageway 21 (FIGS. 1, 2, 3, 6 and 9). The base 26 is a rectangular plate having a certain thickness and comprises a groove 21 in longitudinal direction, which corresponds to the passageway 21 for the fibers. The groove 21 comprises a rectilinear zone 22 and a divergent zone 23. The rectilinear zone 22 has constant width and depth from the one side of the base 26 to the point 231, which is the inter connection of the rectilinear zone 22 and the divergent zone 23 as shown FIGS. 6, 7 and 9. The divergent zone 23 preferably has a constant depth but same may be varied over its length in order to get the best spread for the fibers. The zone 23 comprises sidewalls 234, which diverge outwardly at an angle α° from the point 231 to an exit end 232 on the back surfaces of the base 26 as shown FIGS. 6, 7 and 9. The cover 25 and the base 26 are joined together by convenient joining means, such as screws or clamps (not shown). The groove 21 of the base 26 and the bottom surface of the cover 25 form a passageway 21 for filaments as shown in FIGS. 6, 8 and 9. The passageway 21 has an inlet opening 211, an outlet opening 232, a divergent zone 23 provided by the divergent zone 23 of the base 26 and the cover 25, and an inner channel 22 provided by the rectilinear zone 22 of the base 26 and the cover 25.

The air outlet 24 is preferably positioned so as to be within the inner channel 22 and immediately upstream from the divergent zone 23 so that the compressed air, applied to the fiber strand, breaks up links between the individual filaments without wasting air. In case that the assembly does not comprise the rectilinear inner channel 22, the air outlet 24 may be adjacent to the entrance end 231 of the divergent zone 23. The small holes disposed in the air outlet 24 may be one or more and the number of the holes may be varied as well as their placing arrangement, as per input strand width and the requirement to achieve optimum opening of this strand into either smaller strands or individual fibers. The small holes may be aligned across the width of the inner channel 22 as shown in FIGS. 37 and 38. As illustrated, through hole 242 corresponding to a passageway for air passes through the cover 25 at an angle, preferably substantially perpendicular with respect to the passage 21 for filaments. However, it is possible to orient the through hole 242 to practically desired angle to achieve the best separation.

The diverging angle α° of sidewall 234 of the divergent zone 23 is preferably from 10° to 50°.

It is to be mentioned, that the angle α° is selected in such way as to achieve the desired width for the spread fibers, which will depend upon the width requirement for subsequent processing. Thus, if wider spread is required, larger angles will need to be selected. The length of the inner channel 22 is preferably comprised between 10 and 30 mm. The width, w₍₂₂₎, and the height, h₍₂₂₎, of a cross-section of the inner channel 22 is selected in accordance with the input fiber strand width as well as thickness so that the input fiber strand easily passes through the channel 22, allowing efficient use of air for separating the strand into individual fibers. The inner channel 22 has a rectangular cross-section with an aspect ratio, i.e., AR₍₂₂₎=w₍₂₂₎:h₍₂₂₎, of at least 2:1, preferably at least 3:1, more preferably at least 4:1, even more preferably at least 8:1, even further more preferable at least 12:1. The filament passageway 21 may comprise only a divergent zone 23 without any rectilinear channel. If only breaking up of the links, existing between individual filaments, is needed and no further spreading or fanning out of the individual filaments is required, a smallest possible α° may be selected, preferably less than 2°. The depth of the divergent zone 23 may be gradually varied. The width and the length of the divergent zone 23 may also be suitably altered to obtain desired dimensions or desired cross-section area for the spread fibers.

FIG. 10 shows as an example an opening and spreading process of a fiber strand within a passageway 21 comprising a divergent zone 23 having sidewalls 234 that diverge at an angle α° from the inner channel walls as the fiber strand moves in the direction represented with the arrow A and where the compressed air is applied perpendicularly to the fiber strand at a point immediately upstream of the divergent zone. The arrow represents the principal moving direction of the fibers.

A fiber strand may be supplied from a fiber strand source, such as a commercially available spool or roving. The fiber stand source may be placed on a rotating disk and the rotating speed for feeding the strand may be controlled with servo motor. By synchronising the feeding speed and the pulling speed defined by a pulling means placed downstream of the spreader assembly and by keeping overfeeding of fibers, the fibers can benefit from a tension free condition which in turn can force the opened fibers to spread along the divergent zone of the spreader assembly and to uniformly arrange in a plane arrangement. The fiber strand is passing in the passageway 21 across the spread assembly 2 through an inlet opening 211. The fiber strand can move or pass freely through the inner channel 22 of rectilinear shape and diverging zone 23 of the passageway. The passing fiber strand attains the velocity according to the pulling force applied by the in-line subsequent process or by any suitable means. No special or separate pulling device is needed, in the case where the subsequent process equipment commands the pulling of the fibers. For example, a motorized rotating cylinder, a tube, mandrel or a panel may pull the fibers during the winding process at a given winding speed. Also in another example, the impregnated fibers may be shaped into a rod and be pulled by a chopper to make pellets of desired length. As it is understood, the speed will be determined by the speed requirement of the subsequent process such as pelletization. For example, the pelletization may be run at a speed of dozens to hundreds meter/min.

Compressed air flow supplied to the air passage through the air inlet 241 may be applied to the fiber strand 5 at an angle, preferably perpendicularly, within the passage through small holes disposed at the air outlet 24. The air pressure may be selected depending upon the strength of the links between individual fibers. The preferred pressure of air flow entering into the spreader assembly 2 is in the range of approximately 0.1 to 5 bars. For a commonly available commercial strand, air pressures of 0.5 to 3 bars may very well be suited to get good opening of fibers. A pressure gradient is created across the divergent zone 23. Due to the pressure differential, the air entering the divergent zone 23 through its entrance end 231 flows through the entire width of the divergent zone 23 toward the outlet end 232 thereof. Accordingly, at first the perpendicular air flow through smaller holes breaks up the links between individual filaments in the bundled fiber strand 5 created by, for example, a sizing or binding agent, physico-chemical interactions, electrostatic force, mechanical, compaction or friction forces, and then, the divergent air stream created in the divergent zone forces the loosened and separated strands or filaments to spread widely and to disperse uniformly as shown in FIG. 10. In this application, the word “open” or “separate” means to break up the links between individual filaments in the bundled fibers (strand), and the word “spread” means to make the distance between resulting smaller strands or individual filaments greater.

An advantage of the invention is that it may be practiced upon two or more fiber strands at once that are spread widely and dispersed uniformly by using a spreader assembly comprising two or more spreader units having one or more than one of filament passageways disposed one above the other or side by side. It is, with proper combination therefore, also suitable for manufacturing a composite structure comprising a large amount of reinforcing fiber. Thus, several spreader units having one or more than one of filament passageways may be combined together and placed in such a combination as to obtain desired width for the spread fibers and at the same time desired amount of glass % by weight required for the in-line subsequent processing into a composite reinforced structure. Furthermore, by connecting each inlet for air of the spreader units to an air compressor by conventional means, all spreader units may share one air supply.

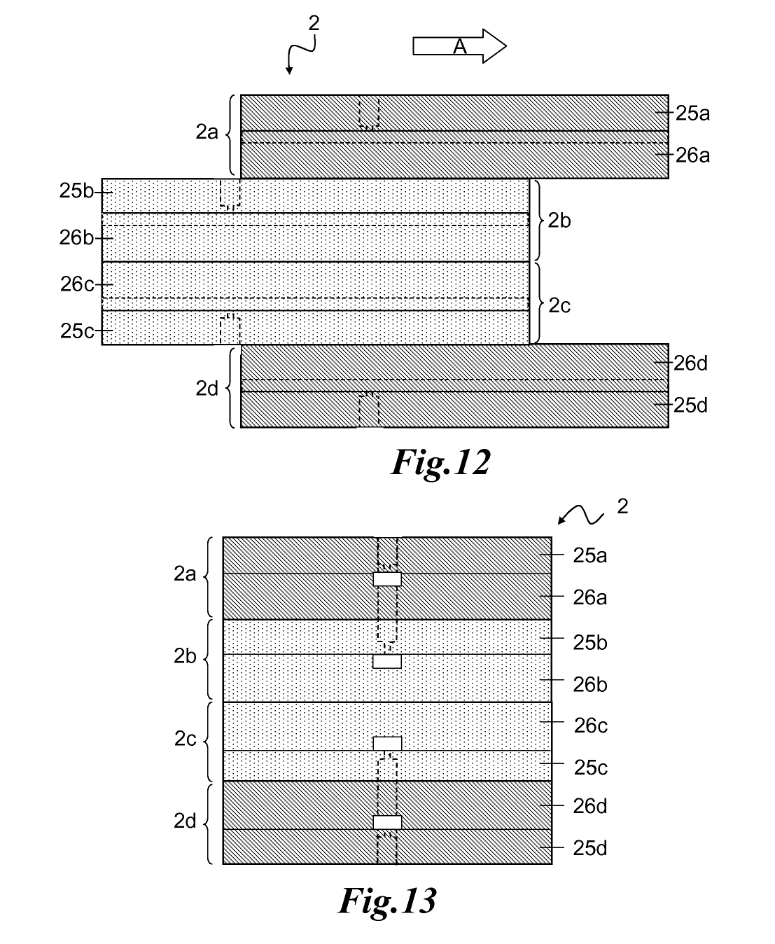

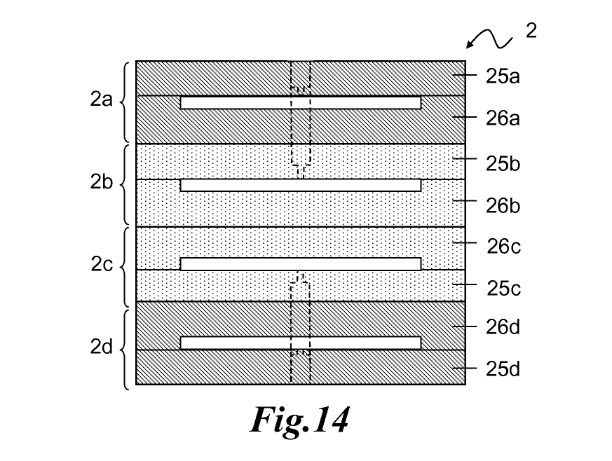

FIGS. 11 to 14 illustrate an embodiment of a spreader assembly comprising four spreader units, two external units 2a, 2d and two inner units 2b, 2c, which are disposed one above the other. Although the individual spreader units may have different structures adapted for use in combination with each other, each spreader unit, preferably has the same structure as described above and illustrated in FIGS. 1 to 9. The base 26a of the upper external unit 2a is in contact with the cover 25b of the upper inner unit 2b which is just underneath. The upper external unit 2a mounted on the upper inner unit 2b is horizontally shifted in the direction of fiber movement (represented with the arrow A in FIG. 12) so that the air inlet 241b of the upper inner unit 2b is uncovered and can be connected to a compressed air supply. Each air inlet 241a, 241b may be connected to a compressed air supply by a conventional means (not shown). A second inner unit 2c is mounted under the upper inner unit 2b without any horizontal shift. And a second external unit 2d is mounted under the second inner unit 2c and shifted horizontally in the direction of the fiber movement. According to other embodiments more than four spreader units may be stacked.

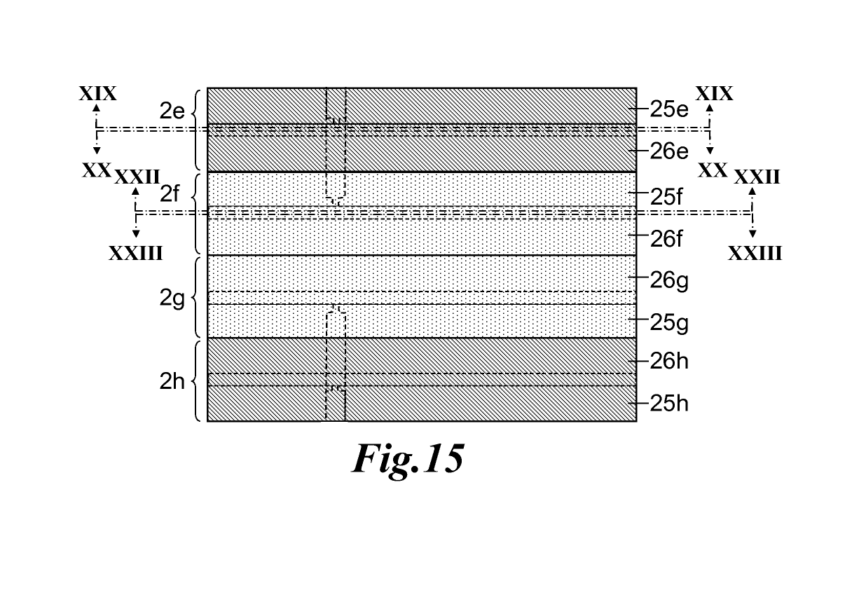

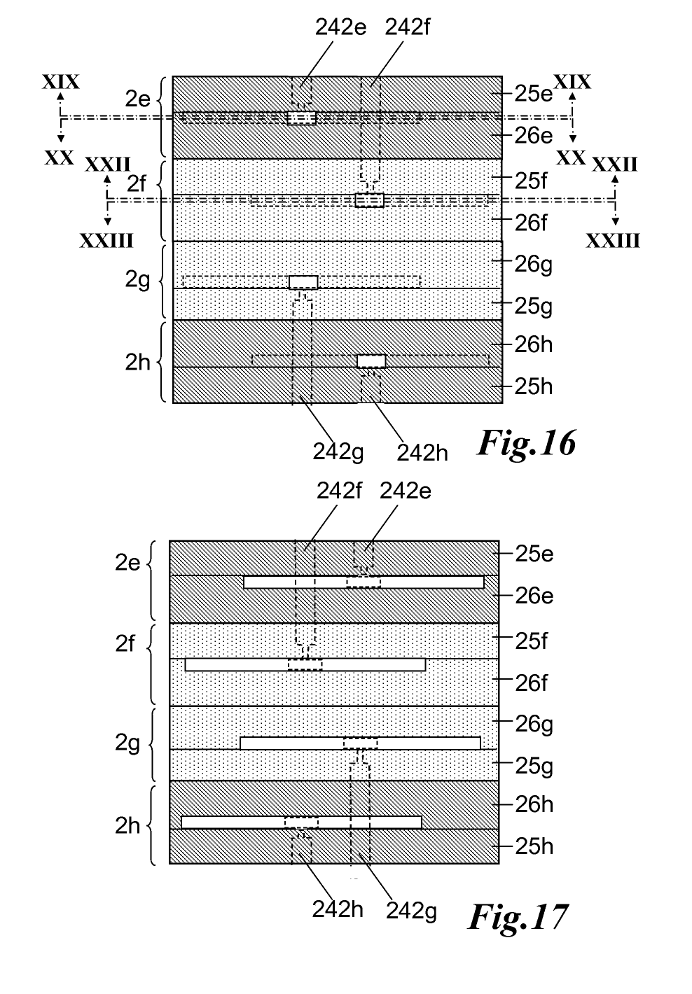

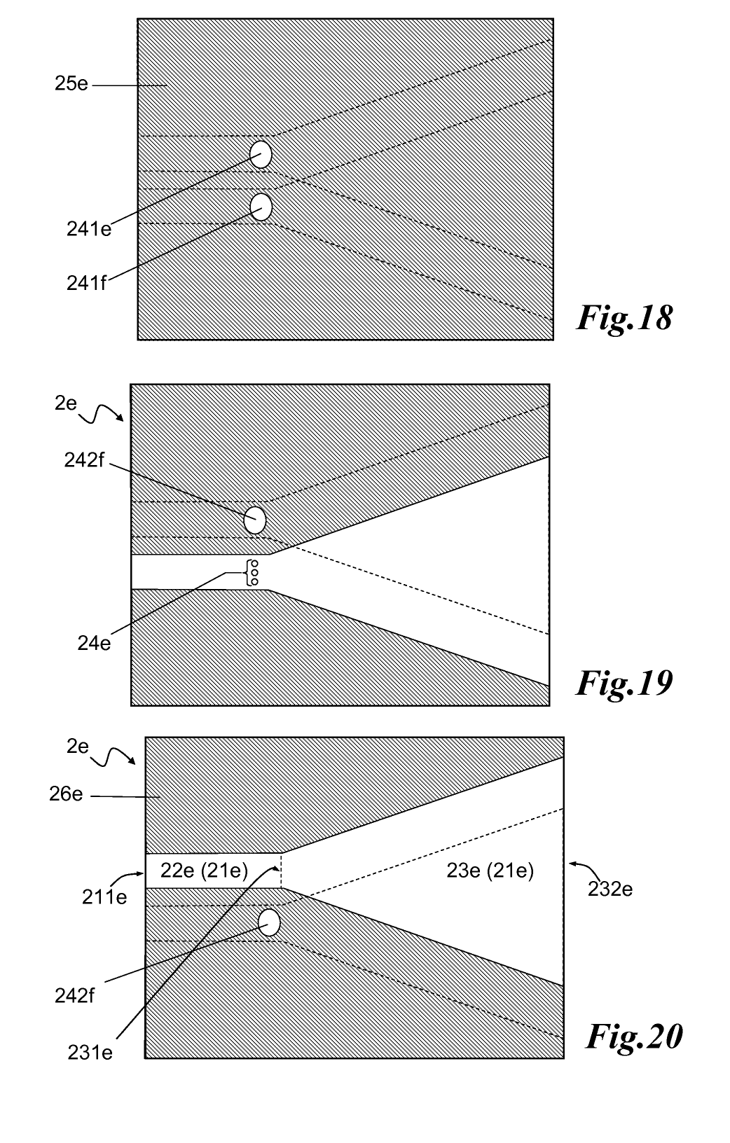

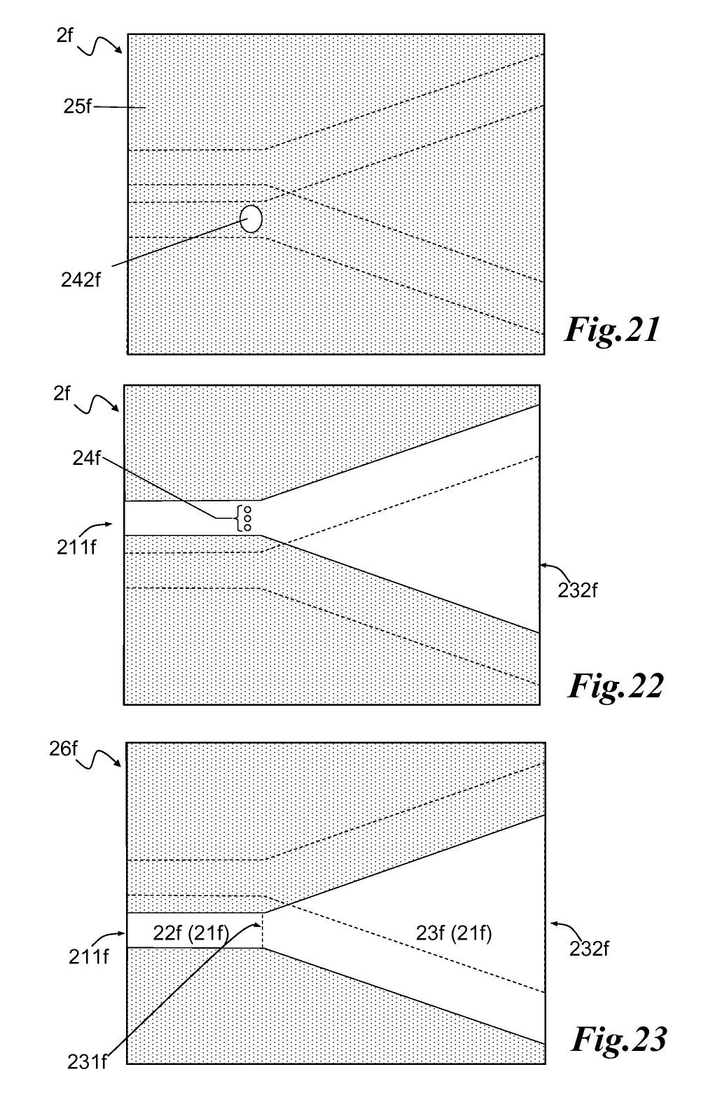

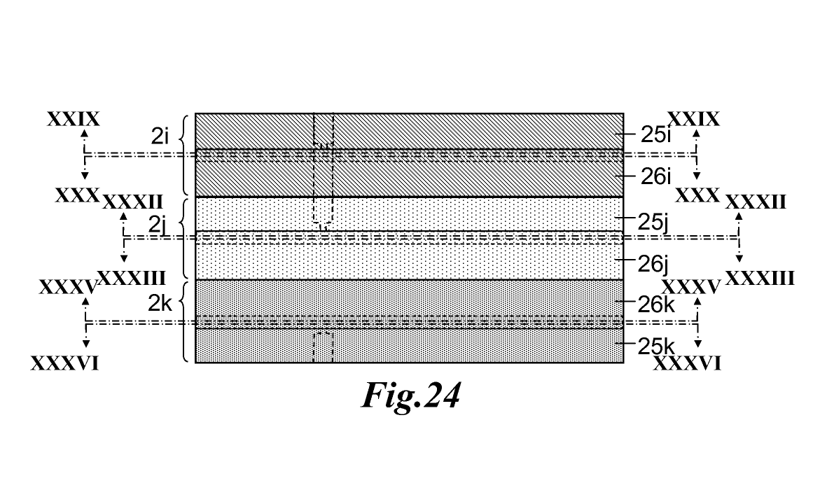

FIGS. 15 to 23 illustrate another preferred embodiment of a spreader assembly 2 according to the present invention comprising four spreader units, 2e, 2f, 2g and 2h. The upper spreader unit 2e comprises a cover 25e and a base 26e which are joined together by a conventional means such as screws or clamps (not shown). The cover 25e of the spreader unit 2e comprises two through holes 242e and 242f corresponding to air passages as shown in FIGS. 16, 17 and 19 to 21. One through hole 242e is connected to the air outlet 24e of spreader unit 2e and the other 242f is connected to the through hole 242f disposed in the base 26e of unit 2e which has a structure similar to the structure of the base 26a as described above. The hole 242e allows the supply of air into the passageway 21e of the upper spreader unit 2e and the hole 242f allows the supply of air into the passageway 21f of an inner unit 2f underneath. The hole 242f, therefore, passes through the cover 25e, the base 26e and the cover 25f. The base 26f of the inner unit 2f comprises a groove 21f which has a structure similar to the structure of the groove 21e of the base 26e but is shifted into a lateral direction in order to avoid overlapping of the position of the through hole 242f with the one 242e of unit 2e. The inner units 2f and 2g are joined together with their respective bases 26f and 26g. FIG. 39 shows a snap shot of this spreading using the spreader assembly comprising four spreader units. It shows that four fiber strands are opening and widely spreading into individual filaments.

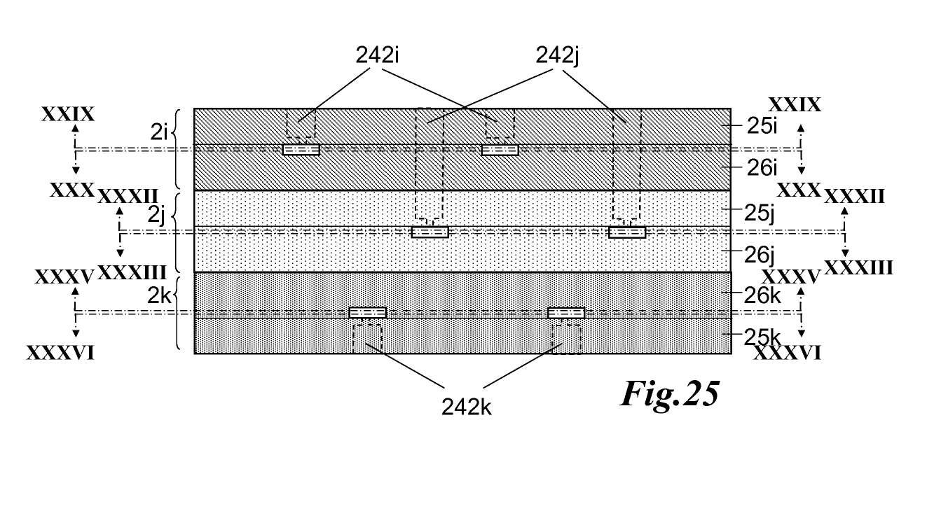

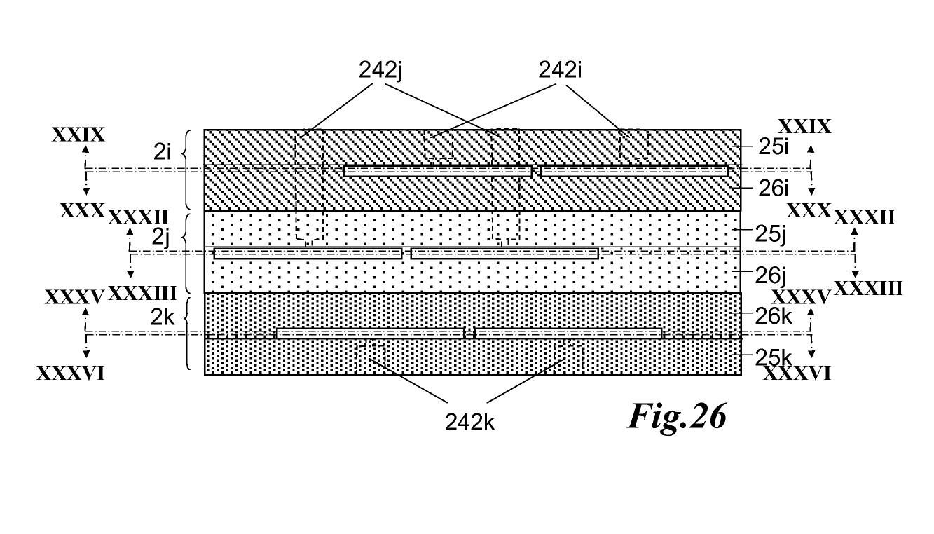

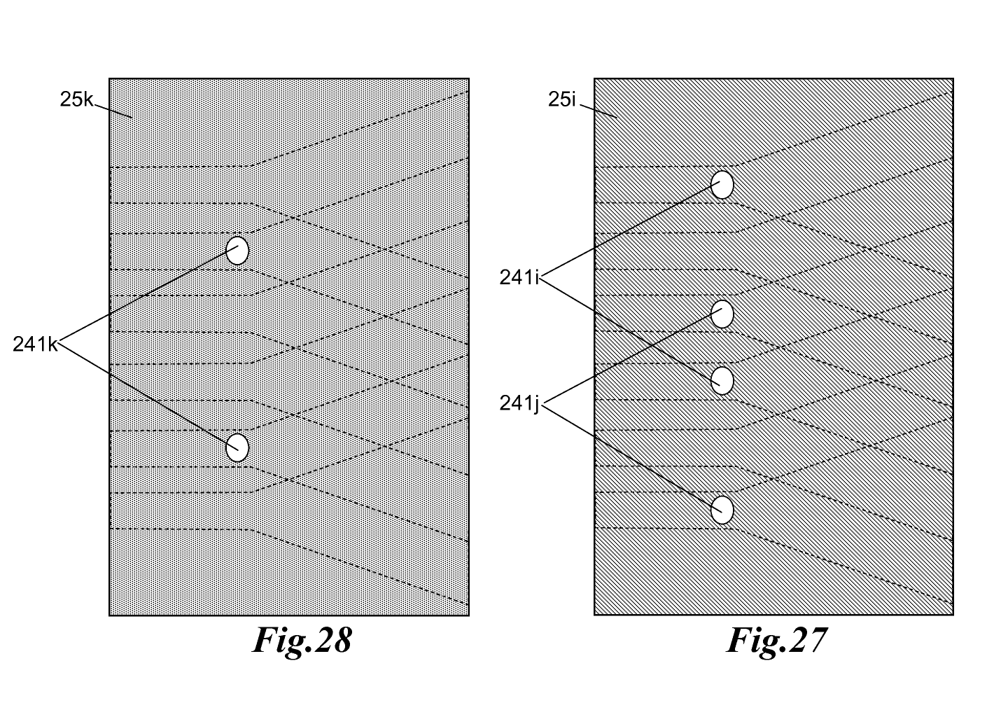

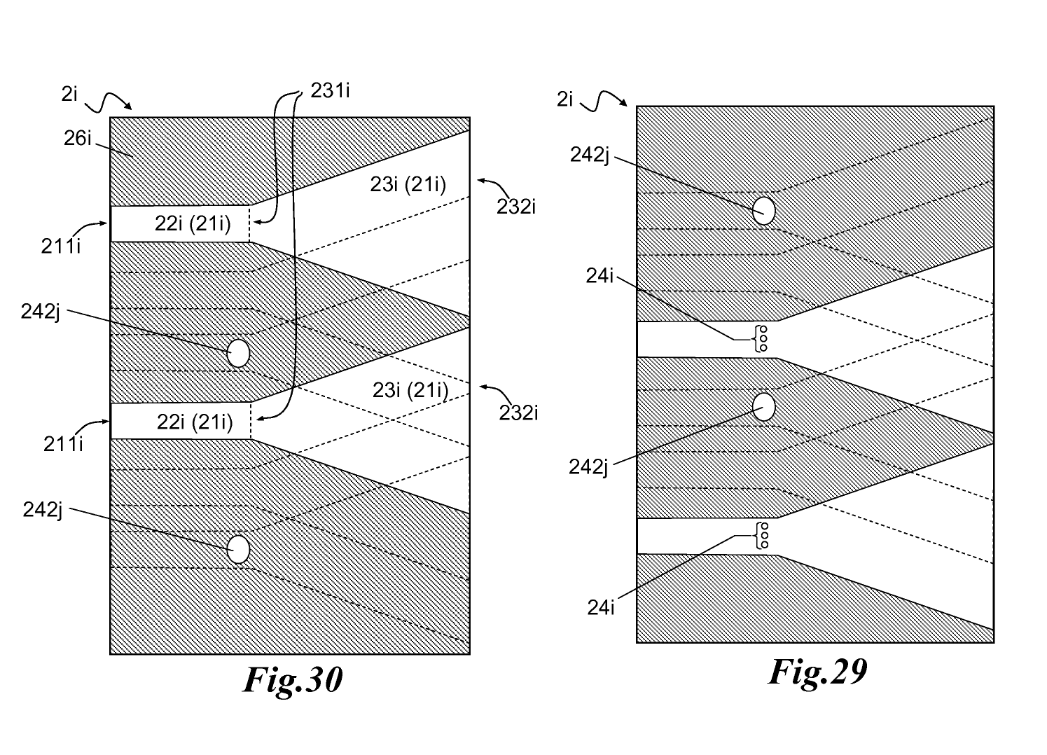

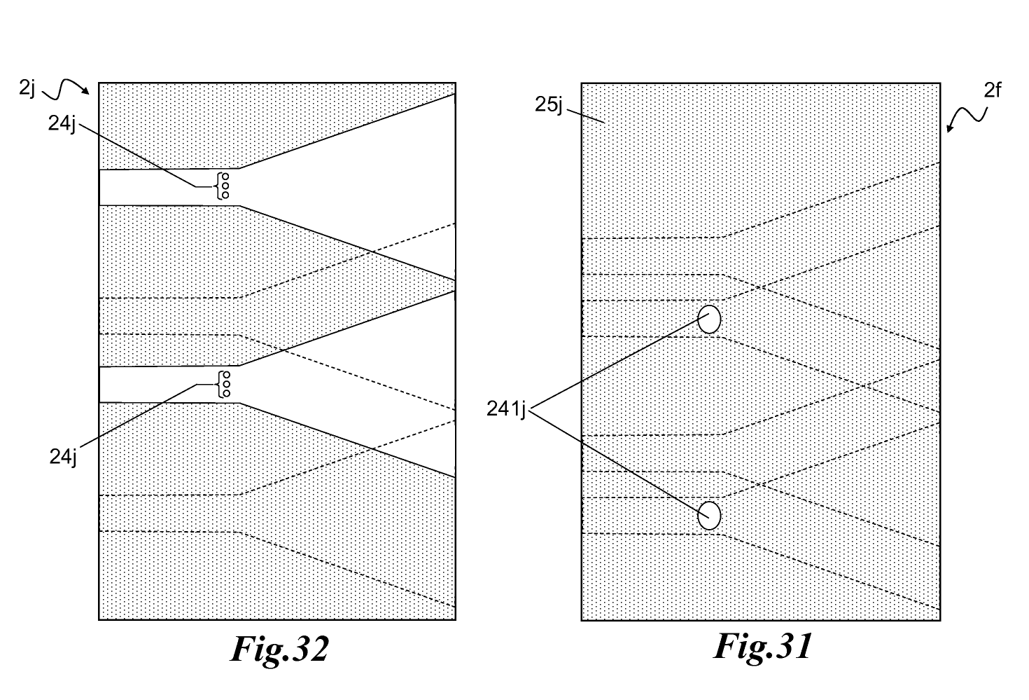

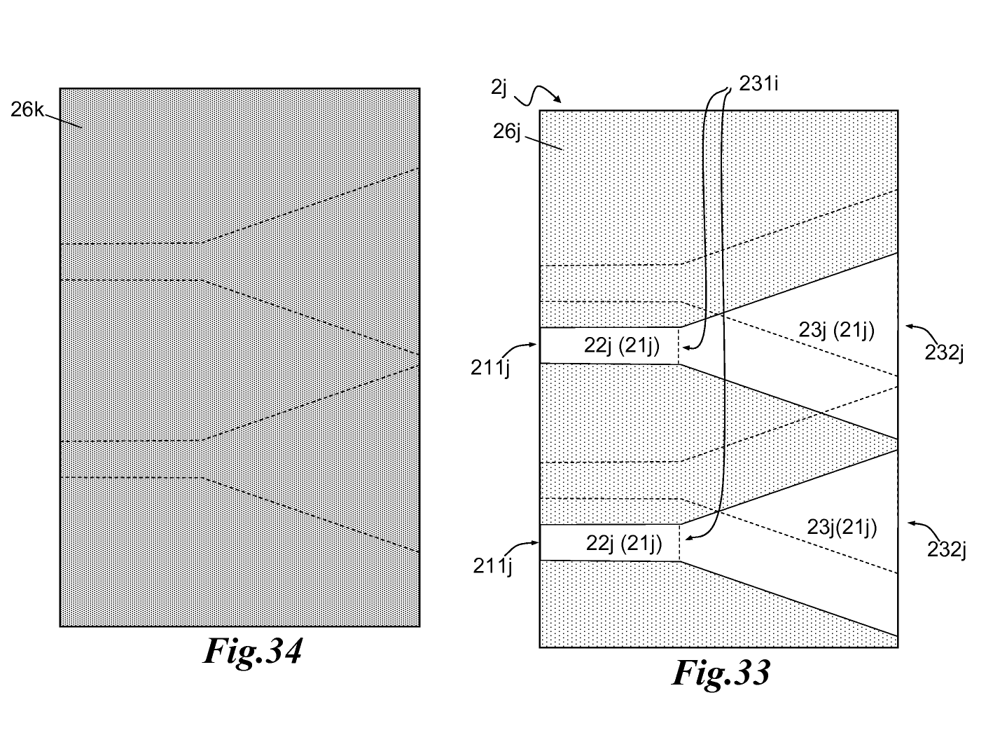

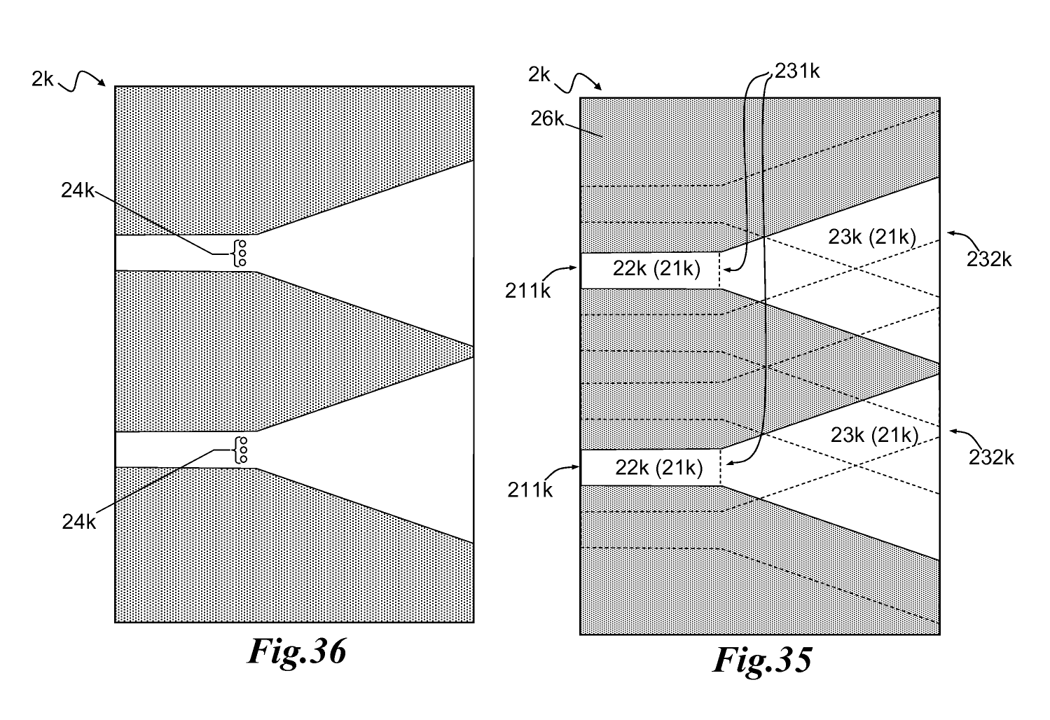

FIGS. 24 to 36 illustrate another preferred embodiment of the spreader assembly 2 according to the present invention comprising three spreader units, 2i, 2j and 2k, wherein each unit has two passageways 21 and two air though holes 242. This assembly can provide a plurality of separated and spread filaments in a short space at high operation speed. Each spreader unit, 2i, 2j and 2k, comprises a cover, 25i, 25j and 25k, and a base, 26i, 26j and 26k, which are joined together by a conventional means such as screws or clamps. Each unit, 2i, 2j and 2k, comprises a pair of passageways for filaments, 21i, 21j and 21k, placed in parallel to each other. The pairs of passageways 21i and 21j of units 2i and 2j are shifted in a lateral direction in order to avoid overlapping of the position of the through holes 242i of unit 2i with the one 242j of unit 2j. The pair of passageway 21k of the unit 2k is positioned in the middle of the unit 2k. The cover 25i of the spreader unit 2i comprises four through holes 242i and 242j corresponding to air passages. The two through holes 242i are connected to the passageways 21i via the air outlet 24i relatively and the other through holes 242j are connected to the passageways 21j via the through holes 242j relatively. The holes 242j pass through the cover 25i, the base 26j and the cover 25j. The cover 25k of the spreader unit 2k comprises two through holes 242k corresponding to air passages. The through holes 242k are connected to the passageways 21k via the air outlet 24k relatively. The inner unit 2j and the bottom unit 2k are joined together with their respective bases 26j and 26k.

According to the invention, the fiber strand may be separated and spread into individual fibers so that it may be directly or indirectly coated, soaked, submerged, dipped, infused or impregnated with substances e.g., solids such as powders, or liquids such as solutions, emulsions, dispersions of polymers, molten polymers, waxes, to form a composite structure. For example, the spread fibers, could be wound on a core and later infused with a substance, or directly impregnated with a resin matrix substance.

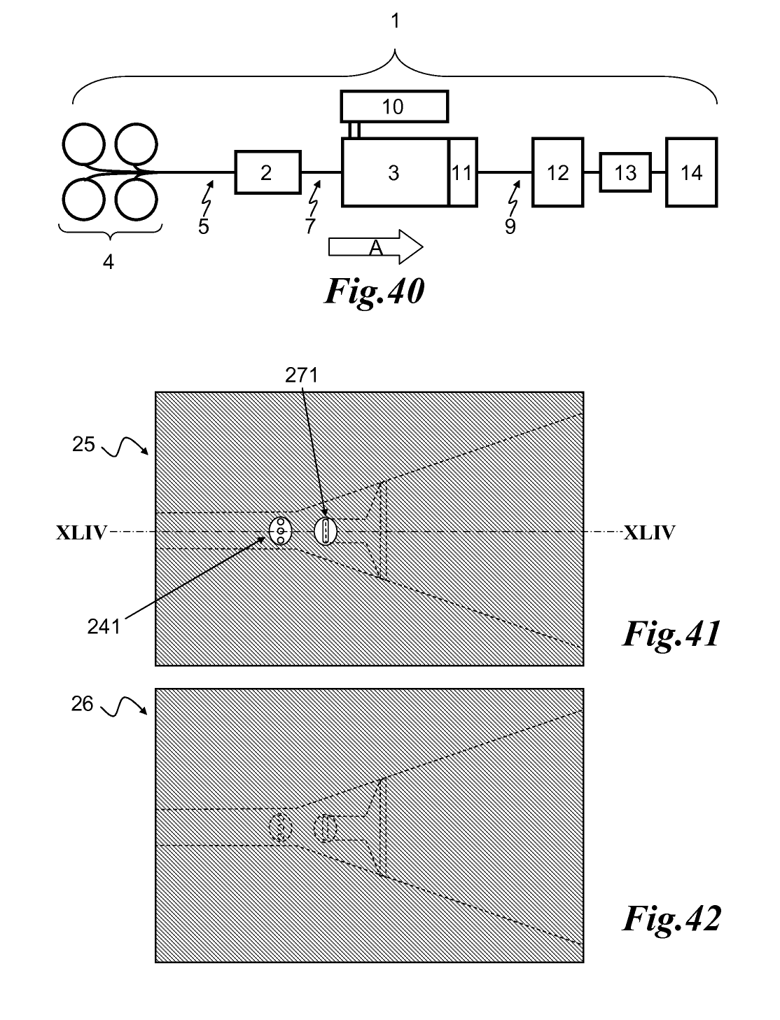

FIG. 40 schematically shows preferred embodiment of the process equipment according to the present invention, for manufacturing a composite structure reinforced with continuous fibers comprising the spreader assembly of the present invention. Fiber strands 5 may be supplied from fiber strand spools and fed through a spreader assembly 2 according to the present invention by a conventional pulling mechanism of subsequent process 13. The resulting fiber-opened strand 7 may be directed into an impregnation assembly 3 and subjected to an impregnation with impregnation material brought from a source such as an extruder 10. The resulting impregnated fiber strand 9 may be shaped to have a desired shape with a shaping die 11, such as a round strand, rod, ribbon, tape, plate, tube or any other special shape. The resulting product 9 may be cooled by a cooling means 12 or allowed to solidify or cure. The cooled, solidified or cured profiles may be cut to desired lengths. In the alternative, the resulting product 9 may be wound into a product such as pipe, cylinder, tube and panel, before cooling, solidification or curing. Also a readily formed rod may be cut to desired length with 14 using a cutter or a pelletizer to produce reinforced pellets which can be subsequently molded into composite parts. Such pellets with majority of fibers impregnated can disperse well within the matrix to be reinforced and lead to high performance composites even when molded at milder shear conditions. The obtained long fiber reinforced composite structure comprises reinforcing fibers which may be well impregnated with the impregnating material.

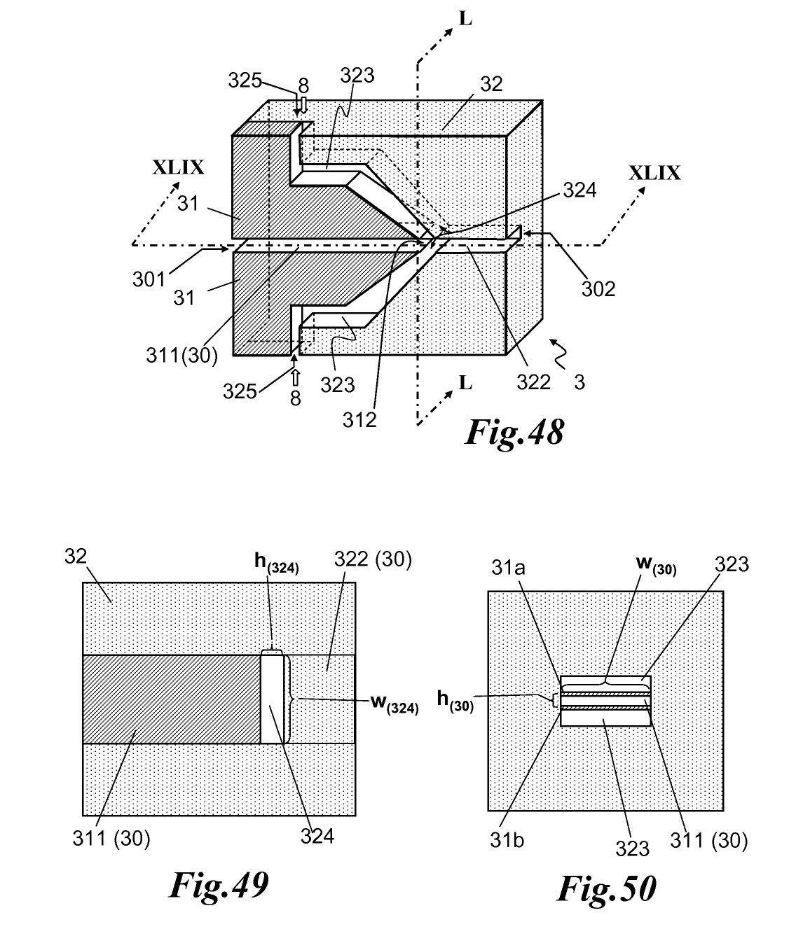

The process equipment according to the present invention may further comprise an impregnation assembly 3. A specific structure of the impregnation assembly 3 is described in more details in FIGS. 48 to 37. Specifically, impregnation assembly 3 comprises a passageway 30 for filaments having an entrance end 301 and an exit end 302 and two passageways 323 for the impregnating substance having each an inlet 325 and an outlet 324.

The impregnating substance flows from the passageway 323 to the passageway 30 for filaments via the outlets 324 and enters into contact with the filaments. These outlets 324 are at the initial meeting point of the filaments with the impregnating substance. The passageway 30 for filaments has an oblong cross-section, preferably a substantially rectangular cross-section at the initial meeting point. The aspect ratio of said cross-section of passageway 30 is represented as AR₍₃₀₎ in FIG. 50 which is the ratio of its width, w₍₃₀₎, to its height, h₍₃₀₎, i.e., AR₍₃₀₎=w₍₃₀:h₍₃₀₎. The aspect ratio AR₍₃₀₎ at the initial meeting point is at least 2:1, preferably at least 3:1, more preferably at least 4:1, even more preferably at least 8:1 and even further more preferably at least 50:1 in order to obtain a better impregnation. The intersections of the two outlets 324 for the impregnating substance with the passageway 30 have an oblong shape and are located across the passageway 30 and opposite to each other. The aspect ratio of the intersections are represented as AR₍₃₂₄₎ in FIG. 49 which is the ratio of its width, w₍₃₂₄₎, to its height, h₍₃₂₄₎, i.e., AR₍₃₂₄₎=w₍₃₂₄₎:h₍₃₂₄₎.

In a preferable embodiment described in FIGS. 48 to 50, the impregnation assembly 3 is composed of an inner die 31 and an outer die 32. The inner die 31 defines a passage space 311 having an entrance end 301 and a projection end 312 which is a part of the passageway 30. The outer die 32 comprises an inner space 321, an exit passage 322 which is a part of the passageway 30, two passages 323 for the impregnating substance, two inlets 325, and two outlets 324 the shape of which is defined by positioning the inner die 31 with respect to the inner space 321 of the outer die 32. The width of the passage space 311 may be essentially the same as the one of the passageway 30 as shown in FIG. 49. The projection end 312 of the inner die 31 has a flat cross-section, preferably rectangular cross-section. The projection end 312 is positioned inside of the inner space 321 of the outer die 32 to make the two outlets 324 for the impregnating substance having an oblong shape and being located opposite to each other and across the passage 30. In the passageway 30 of the impregnation assembly 3, the passage space 311 and the exit passage 322 are aligned.

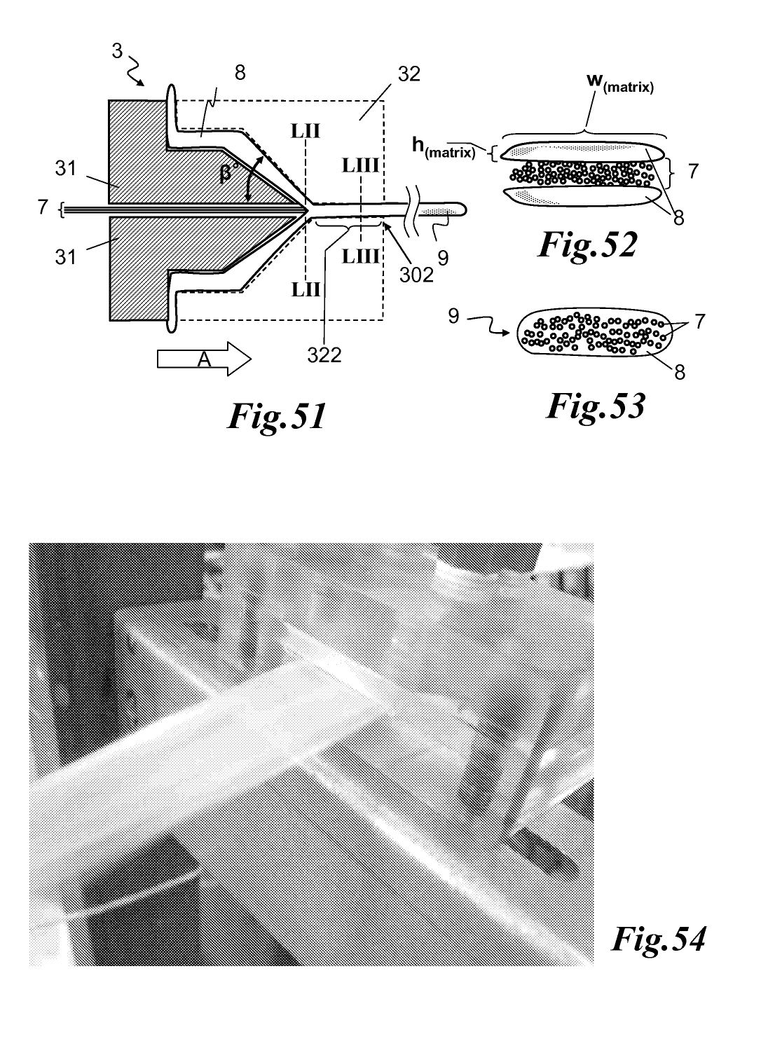

FIGS. 51 to 53, show a preferred process for the impregnation using the impregnation assembly 3. The impregnating substance 8 is provided through the passage 323 of the outer die 32 illustrated in FIGS. 48 to 50 via the two outlets 324 to the passageway 30 of the impregnation assembly 3 and meets the bundle of fibers 7 passing through the passageway 30. The bundle of fibers 7 in this context is a number of filaments which are separated and spread substantially individually, and are guided and arranged in a plane, within the spreader assembly according to the present invention prior to entering the impregnation assembly 3. In the passage 30 having a flat cross-section with an aspect ratio i.e., AR₍₃₀₎=w₍₃₀₎:h₍₃₀₎, of at least 2:1, preferably at least 3:1, more preferably at least 4:1, even more preferably at least 8:1 and even further more preferably at least 50:1. The outlets 324 have oblong or rectangular shapes with an aspect ratio, i.e., AR₍₃₂₄₎=w₍₃₂₄₎:h₍₃₂₄, of at least 2:1, preferably at least 3:1, more preferably at least 4:1, even more preferably at least 8:1, and are located opposite to each other. The spread bundle of fibers 7 meets the two flows of impregnating substance 8 introduced to the passageway 30 via the outlets 324 at 30° with respect to the moving direction (A) of the filaments. The two flows of impregnating substance 8 having an oblong cross-section with an aspect ratio, AR₍ₘₐₜᵣᵢₓ₎=w₍ₘₐₜᵣᵢₓ₎:h₍ₘₐₜᵣᵢₓ₎, of at least 2:1, preferably at least 3:1, more preferably at least 4:1, even more preferably at least 8:1 , sandwich the filaments and pass through the exit passage 322 of the outer die 32 together with the sandwiched filaments while impregnating the filaments, and then exit the impregnation assembly 3 via the exit end 302 as a unitary impregnated fiber-reinforced composite product 9. The injection angle (β°) of the impregnating substance into the passageway 30 defined by the divergent zone of the passage 323 may be less than 90° with respect to the direction (A) of filaments, preferably from 15° to 85°, more preferably from 30 to 60°, so as to facilitate feeding filaments ahead and assist the impregnation process without any breakage of filaments. The combination of this injection angle and the injection pressure provided by the two opposite layers of the impregnating matrix allow the air trapped within a bundle of filaments arranged in a plane to escape upstream and results in a good impregnation under high operation speed.

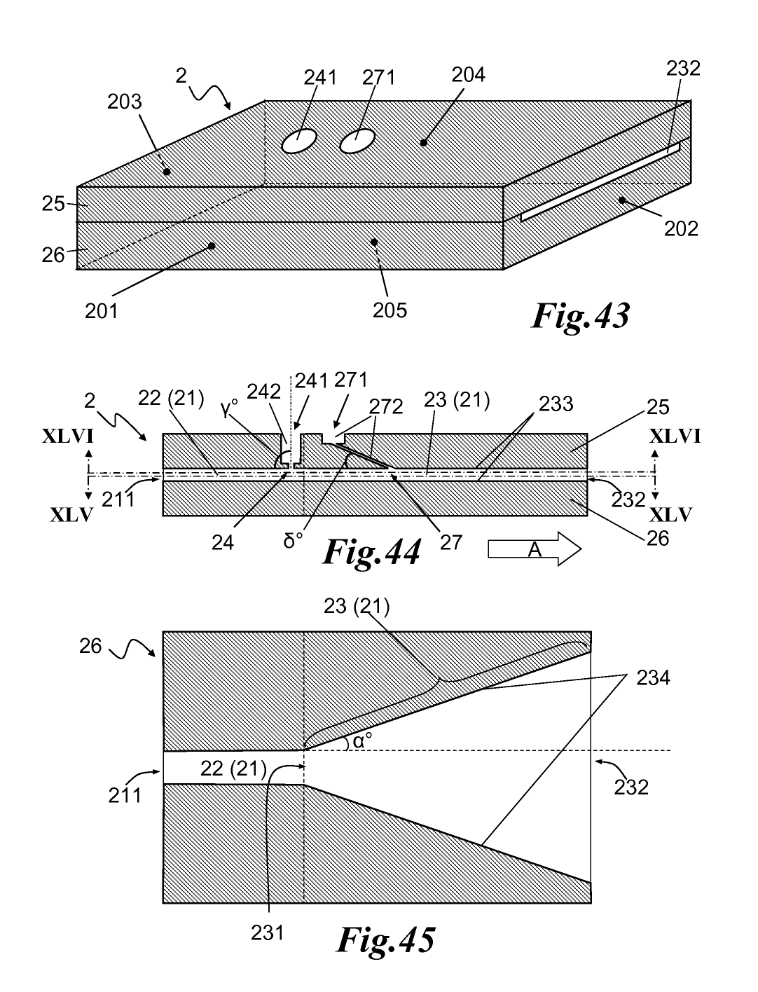

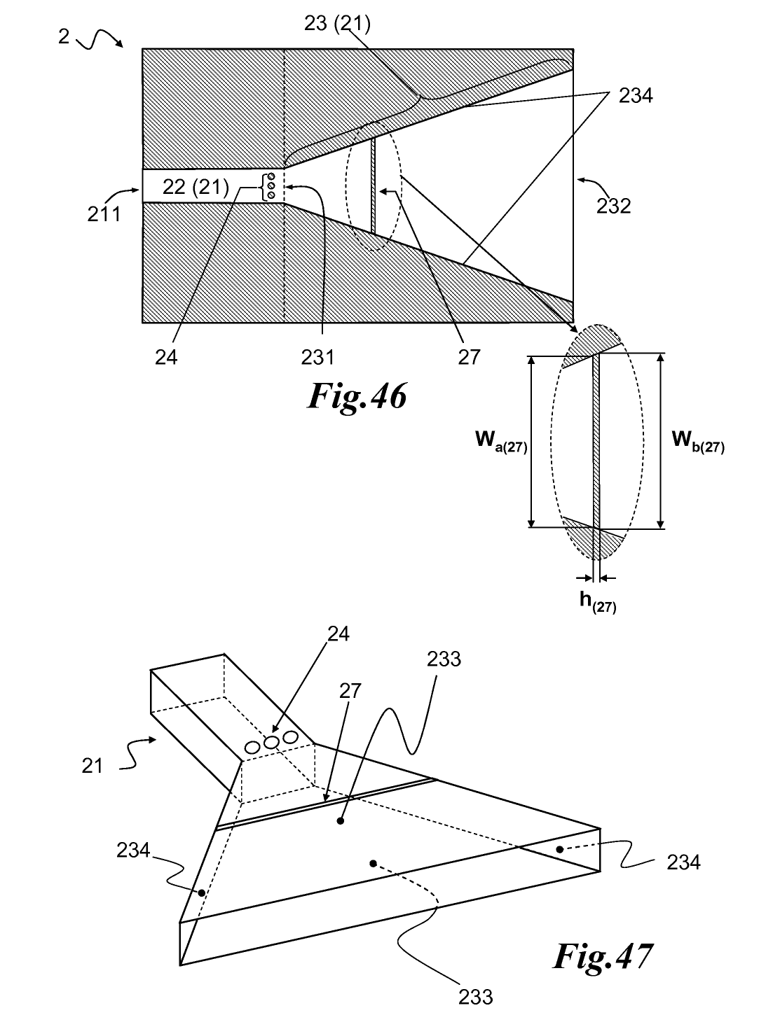

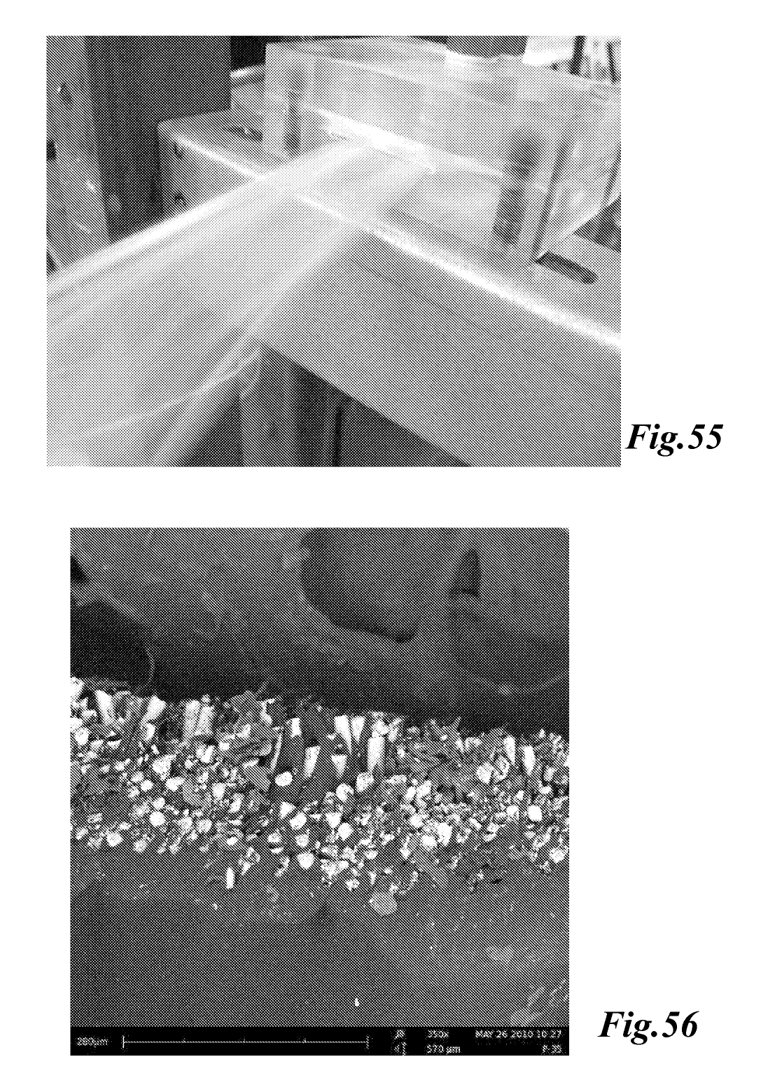

FIGS. 41 to 47 illustrate another preferred embodiment of the spreader assembly 2 according to the present invention comprising a second through hole 272 connected to the divergent zone 23 at the oblong intersection 27. As shown in FIGS. 43 and 44, the spreader assembly 2 is provided with a spreader unit having a cover 25 and a base 26 to be joined together so that a passageway 21 for the fibers is provided as illustrated in FIG. 47. The spreader unit comprises two side surfaces 201, a back surface 202, a front surface 203, a top surface 204 and a bottom surface 205 as illustrated in FIG. 43. The cover 25 is a rectangular plate having a certain thickness and comprises a first through hole 242 and a second through hole 272 passing through the thickness of the cover 25 as best shown in FIG. 44. The first through hole 242 corresponds to a passage for air connected to an inner channel (22) as shown in details in FIG. 44. The second through hole 272 is connected to an divergent zone 23 at an angle (δ) of from 15° to 75°, preferably 30° to 60° with respect to the moving direction of the filaments, as shown in FIG. 44. One of the ends of the first through holes 242 and the second through hole 272 corresponds to a first air inlet 241 and a second air inlet 271, respectively (as shown in FIGS. 41 and 43), which are disposed on the top surface 204 of the cover 25. The opposite end of the first through hole 242 corresponds to a first air outlet 24 having at least three small holes and the one of the second through hole 272 corresponds a second air outlet 27 having an oblong shape as shown FIG. 46 with an aspect ratio of at least 4:1, preferably at least 10:1, more preferably at least 30:1, so as to force the filaments separated with the air flow provided via the first through hole 242 to spread along the walls of the divergent zone. FIG. 54 shows a snap shot of the spreading fibers using the spreader comprising the first through hole 242 only, and FIG. 55 shows the one using the spreader with the first hole 242 and the second one 272 both. With the second hole, the fibers are spread wider and more uniformly. The aspect ratio of the second air outlet 27 is defined as AR₍₂₇₎={(wₐ₍₂₇₎+w_{b(27)})/2}:h₍₂₇₎. The width of said outlet 27 represented as wₐ₍₂₇₎ is shorter than the opposite width w_{b(27)} thereof as illustrated in a zoomed-in view of FIG. 46. The second air outlet 27, which is the intersection of the through hole 272 with the divergent zone 23 may have essentially the same width as the divergent zone. The bottom surface of the cover 25 forms a top wall for the passageway 21 (FIGS. 46 and 47). Said spreader assembly may comprises two or more spreader units having one or more than one of filament passageways with the first and second through holes, disposed one above the other or side by side so as to obtain desired width for the spread fibers and at the same time desired amount of glass % by weight required for the in-line subsequent processing into a composite reinforced structure.

### EXAMPLES

### Example 1

A spreader assembly according to the present invention was arranged in a manner to have one passageway, enabling one inlet opening for glass fiber strands (SE4220 direct roving).

The passageway comprised an inner channel of rectilinear shape and a divergent zone and had a total passageway length of 60 mm, with the inner channel having dimensions of 30 mm×6 mm×0.6 mm followed immediately by the divergent zone having 30 mm in length with a divergence angle of about 26.6°, leading to dimensions of 30 mm×0.7 mm for the exit. The strand went through the inlet opening of 6 mm×0.5 mm, which was also the start of the inner channel of rectilinear shape of the passageway, and one exit end of 30 mm×0.7 mm, which was also the exit of the divergent zone of the passageway. The air, at 0.8 bar pressure, was supplied to the passageway through an air through hole leading to the inner channel of the passageway. The air through hole led to three finer holes of 1 mm diameter each, arranged across the inner channel width and located immediately upstream of the entrance end of the divergent zone. The fibers were pulled by a pulling/winding mechanism from the outlet at a speed of 60 m/min. Essentially no broken filaments, no breaking of strand and no fuzz or line stoppages were observed. The quality of spreading i.e. the spread width expected from the spreading unit settings, was assessed by measuring spread width and visually inspecting the spreading on the running line. The fiber strands were opened, separated into smaller strands, and uniformly spread in a plane at the outlet opening of the passageway of the spreader unit and ready to be used as reinforcing fibers in a subsequent reinforcement step as reinforcement fibers. The pulling speed could be increased at least up to 100 m/min without any dropdown of the opening and spreading performance or quality.

### Example 2

A spreader assembly according to the present invention was arranged in manner to have four passageways, enabling four inlets for glass fiber strands (SE4220 direct roving). Each of the four passageways comprised an inner channel of rectilinear shape and a divergent zone and had a total passageway length of 60 mm, with the inner channel having dimensions of 20 mm×6 mm×0.6 mm followed immediately by the divergent zone of 40 mm in length with a divergence angle of about 20.6°, leading to dimensions of 30 mm×0.7 mm for the exit. Each strand went through one inlet opening of 6 mm×0.5 mm, which was also the start of the inner channel of rectilinear shape of the passageway, and one exit end of 30 mm×0.7 mm, which was also the exit of the divergent zone of the passageway. The air, at 1.0 bar pressure, was distributed to the four passageways through their respective air through holes. Each air through hole led to three finer holes of 1 mm diameter each, arranged across the channel width and located at the entrance end of the divergent channel, through which air entered into the inner fiber channel. The four passageways of this assembly were arranged such that the exit ends gave in total a flat spread strand band of 60 mm width, which was guided into an entrance end of the impregnation assembly with the aspect ratio (AR₃₀) of 50:1 (40 mm×0.8 mm). The fibers were pulled by a pulling/winding mechanism from the outlet exit at a speed of 60 m/min. Essentially no broken filaments, no breaking of strands and no fuzz or line stoppages were observed. The quality of spreading i.e. the spread width expected from the spreading unit settings, was assessed by measuring spread width and visually inspecting the spreading on the running line. The fiber strands were opened and separated into smaller strands, and uniformly spread in a plane at the entrance end of the impregnation assembly and ready to be used as reinforcing fibers in subsequent reinforcement step. The pulling speed could be increased at least up to 100 m/min without any dropdown of the opening and spreading performance or quality. Prior to entering into the impregnation die inlet, the moving spread fiber band was heated using a heating gun set at 300° C.

### Example 3

A spreader assembly according to the present invention was arranged in a manner to have six passageways, enabling six inlet openings for glass fiber strands (SE4220 direct roving). Each of the six passageways comprised an inner channel of rectilinear shape and divergent zone and had a total passageway length of 60 mm, with the inner channel having dimensions of 20 mm×6 mm×0.6 mm followed immediately by the divergent zone of 40 mm in length with a divergence angle of about 20.6°, leading to dimensions of 30 mm×0.7 mm dimensions for the exit. Each strand went through one inlet opening of 6 mm×0.5 mm, which was also the start of the inner channel of rectilinear shape of the passageway, and one exit end of 30 mm×0.7 mm, which was also the exit of the divergent zone of the passageway. The air, at 1.5 bar pressure, was distributed to the six passageways through their respective air through holes. Each air through hole led to three finer holes of 1 mm diameter each, arranged across the channel width and located at the entrance end of the divergent channel, through which air entered into the inner fiber channel. The six passageways of this assembly were arranged such that the exit ends gave in total a flat spread strand band of 70 mm width, which was guided into an entrance end of the impregnation assembly with the aspect ratio (ARA of 50:1 (40 mm×0.8 mm). The fibers were pulled by a pulling/winding mechanism from the outlet exit at a speed of 40 m/min. Essentially no broken filaments, no breaking of strands and no fuzz or line stoppages were observed. The quality of spreading i.e. the spread width expected from the spreading unit settings, was assessed by measuring spread width and visually inspecting the spreading on the running line. The fiber strands were opened and separated into smaller strands, and spread uniformly in a plane at the entrance end of the impregnation assembly and ready to be used as reinforcing fibers in a subsequent reinforcement step. The pulling speed could be increased at least up to 100 m/min without any dropdown of the opening and spreading performance or quality. Prior to entering into the impregnation die inlet, the moving spread fiber band was heated using a heating gun set at 300° C.

### Example 4

A spreader assembly according to the present invention was arranged in manner to have one passageway, enabling one inlet opening for glass fiber strands (SE4220 direct roving). The passageway comprised an inner channel of rectilinear shape and a divergent zone and had a total passageway length of 60 mm, with the inner channel having dimensions of 30 mm×6 mm×0.6 mm followed immediately by the divergent zone having 30 mm in length with a divergence angle of about 26.6°, leading to dimensions of 30 mm×0.7 mm for the exit. The strand went through the inlet opening of 6 mm×0.5 mm, which was also the start of the inner channel of rectilinear shape of the passageway, and one exit end of 30 mm×0.7 mm, which was also the exit of the divergent zone of the passageway. The air, at 0.8 bar pressure, was passed to the passageway through an air through hole the inner channel of the passageway. The air inlet hole led to seven finer holes of 1 mm diameter each, distributed uniformly over the circular surface of the air inlet of the air through hole and located immediately upstream from the entrance end of the divergent zone. The fibers were pulled by a pulling/winding mechanism from the outlet exit at a speed of 100 m/min. Essentially no broken filaments, no breaking of strand and no fuzz or line stoppages were observed. The quality of spreading i.e. the spread width expected from the spreading unit settings, was assessed by measuring spread width and visually inspecting the spreading on the running line. The fiber strands were opened and separated into smaller strands, and spread uniformly in a plane at the entrance end of the impregnation assembly and ready to be used as reinforcing fibers for subsequent reinforcement step.

### Example 5

The filaments, opened and uniformly spread with the spreader assembly of Example 3, were used for reinforcing with a thermoplastic polymer with an impregnation assembly according to the present invention at high line speed. A composite structure in which the filaments are uniformly distributed and well impregnated was obtained.

Commercial glass fiber direct roving (GFDR) SE4220 from 3B-Fibreglass was used as glass fiber strand input, made up of 19 μ diameter filaments giving tex (g/km) of 3000. Each GFDR was placed on a free rotating disc mounted on a table to enable easy strand pulling. The unwinding of the GFDR was from outside to avoid any twists during unwinding. Total of six direct roving were used simultaneously for impregnation.

A spreader assembly unit according to the present invention was arranged in six channels, enabling six inlets for glass fiber strands from six direct rovings as shown in FIGS. 24 to 36. Each strand went through one inlet entrance of 6 mm×0.5 mm, which was also the start of the rectilinear part of the channel (inner channel), and exiting through respective outlet, each of 30 mm x 0.7 mm, which was also the exit of the divergent part of the channel (divergent zone). Each of the six channels comprised rectilinear and divergent channel parts and had a total channel length of 60 mm, with a rectilinear channel part having dimensions of 20 mm×6 mm×0.5 mm followed immediately by a divergent channel part having 40 mm in length with a divergence angle of about 20.6°, leading to dimensions of 30 mm×0.7 mm for the exit. The air, at 1.5 bar pressure, was distributed to the six channels through their respective one air inlet hole, essentially perpendicularly to the channel. Each air inlet hole led to three finer holes of 1 mm diameter each, arranged across the channel width and located at a point immediately upstream of the entrance end of the divergent part, through which air entered into the fiber channel.

A flat spread strand band of in total 70 mm width obtained by using the spreader assembly of Example 3 was guided into the impregnation die inlet with AR30 of 50:1 (40 mm×0.8 mm). The fibers were pulled by a pulling/winding mechanism from the outlet exit of the impregnation die at a given speed. No broken filaments, no breaking of strands and no fuzz or line stoppages were observed. The quality of spreading i.e. the spread width expected from the spreading unit settings, was assessed by measuring spread width and visually inspecting the spreading on the running line. Prior to entering into the impregnation die inlet, the moving spread fiber band was heated using a air flow heating gun set at 300° C.

As impregnating substance, thermoplastic injection molding grade Polypropylene with MFR (Melt Flow Rate, MFR expressed in g/10 min at 230° C. & 2.16 kg) of 45 and Mp around 160° was pre-granulated with 1.2% by wt of commercially available maleic anhydride grafted Polypropylene grade Exxelor P01020 having MFR of 430 g/10 min and Mp around 160° C. The pre-granulated thermoplastic matrix was fed into an extruder, set to supply around 400 cm³/min of molten thermoplastic feed to the impregnation die of the present invention attached to its exit. The impregnation die inlet and outlet fixed at AR₃₀ of 50:1 (40 mm×0.8 mm), which also formed the passageway for spread fibers. The two outlets for impregnating substance, which intersected the fiber passageway inside the impregnation die, were set to AR₃₂₄ of 8:1 (40 mm×5 mm). The impregnation die was externally completely covered with heating plates to maintain the temperature at 300° C. The extruder was set to supply around 265-270 cm³/min of molten thermoplastic feed to the impregnation die attached to its exit and fiber puller speed of 20 m/min. The die output of glass filaments impregnated with molten thermoplastic resin showed 60% by wt of glass content and average thickness of around 0.5 mm.

Further flattening or widening of the impregnated filaments was made possible by passing the output of glass filaments impregnated with molten thermoplastic resin over two ceramic rolls, maintained at 250° C. A tape with average width of 60 mm and average thickness around 0.33 mm after cooling was thus obtained. The tape sample was obtained by cooling or quenching, which was done by press holding a cold, wet metal plate, moving at the same rate as the line speed, against the tape surface of the running tape. The microscopic (Phenom Microscope that was coupled with high quality scanning electron microscope with optical camera from FEI Company, USA) pictures reveal that one side of the band was not properly surrounded by the impregnating substance as shown in FIG. 56.

1. A method of reinforcing a substance or an object with continuous filaments comprising the steps of:
(a) supplying a fiber strand from a source of fiber strands;
(b) passing said fiber strand horizontally through a passageway;
(c) subjecting said fiber strand to a fluid such as air flow, within a channel, which is a part of the passageway, of rectilinear shape having an oblong cross-section, at an angle (γ) substantially perpendicular with respect to the moving direction of the filaments so as to separate said fiber strand into a plurality of smaller strands and/or individual filaments; and then
(d) pulling said separated strands and/or individual filaments horizontally through a divergent zone having an exit end and an entrance end and which is a part of the passageway, wherein an area of the exit end is larger than an area of the entrance end and has an oblong cross-section, so as to spread said strands and/or filaments along a diverging wall in a plane; and
(e) reinforcing the substance or the object with the separated and spread strands and/or filaments.

2. The method according to claim 1, wherein said separated strands and/or individual filaments are further subjected within the divergent zone to a fluid, provided through an oblong intersection of a through hole with the divergent zone, at an angle (δ) from about 15° to about 75°, with respect to the moving direction of the filaments.

3. The method according to claim 2, wherein said intersection of the through hole with the divergent zone has an oblong cross-section with an aspect ratio of at least 4:1.

4. The method according to claim 3, wherein said intersection of the through hole has essentially the same width as the divergent zone.

5. The method according to claim 1, wherein the rectilinear channel has a cross-section with an aspect ratio of at least 2:1.

6. The method according to claim 1, wherein the filaments supplied at step (a) are selected from a group consisting of glass fibers, mineral fibers, carbon fibers, graphite fibers, natural fibers, ceramic fibers, metallic fibers, polymeric and syntethic fibers.

7. The method according to claim 6, wherein the filaments supplied by step (a) are coated with a sizing or binding agent.

8. The method according to claim 1 wherein the reinforcing step (e) comprises a step of subjecting the separated and spread strands and/or filaments to a flow of the impregnating matrix substance, and impregnating said strands and/or filaments therewith.

9. The method according to claim 8, wherein the separated and spread filaments are subjected to at least two opposite flows of the impregnating matrix substance, sandwiched and then impregnated therewith.

10. The method according to claim 9, wherein the opposite flows are in the form of a layer having an oblong cross-section with an aspect ratio of at least 2:1, at the initial meeting point of the strands and/or filaments and the impregnating substance.

11. The method according to claim 8, wherein the flow of impregnation substance is applied to said separated and spread strands and/or filaments at an angle (β°) of less than about 90, with respect to the moving direction (A) of the stands and/or filaments.

12. The method according to claim 8 wherein the supplied impregnating substance is in liquid form selected from a group consisting of a solution, an emulsion, a suspension and a dispersion of said polymer in an aqueous or organic carrier, in molten form or in gel form inside the die at any given impregnating temperature.

13. The method according to claim 12, wherein the impregnating substance is a thermoplastic polymer selected from a group consisting of Polyolefins such as Polyamides, Polyimides, Polyamide-imide, Polysulphones, Polyesters, Polycarbonates, Polyurethanes, Polyketones, Polyacrylates, Polystyrene, Polyvinylchloride, ABS, PC/ABS and a mixture thereof, or a thermosetting resin precursor selected from a group consisting of Epoxy, Ester, Urethanes, Phenolic, Alkyd and a mixture thereof.

14. The method according to claim 1 wherein the reinforcing step e comprises a step of arranging the separated and spread strands and/or filaments in a plane and then winding them up onto a core to be reinforced therewith.

15. (canceled)

16. A spreader assembly suitable for separating and spreading a continuous fiber strand into a plurality of smaller strands or individual filaments and arranging said strands or filaments in a plane comprising at least one spreader unit comprising:
(a) at least one passageway having:
an inlet opening for receiving said fiber strand; and
an outlet opening through which said fiber strand exits said passageway;
(b) an inner channel of rectilinear shape disposed within the passageway;
(c) a divergent zone within the passageway having:
an entrance end connecting to the inner channel; and
an exit end,
wherein an area of said exit end is larger than an area of the entrance end, said divergent zone has an oblong cross-section, and said inner channel and said divergent zone are aligned; and
(d) at least one through hole connected to the inner channel at an angle (γ) substantially perpendicular with respect to the longitudinal direction of the passageway through an outlet having one or more holes smaller than the dimension of the through hole, and suitable for introducing the air flow therethrough, wherein the inner channel has a rectangular cross-section with an aspect ratio of at least 2:1.

17. The spreader assembly according to claim 16, wherein the spreader assembly unit further comprises a through hole intersecting with the divergent zone at an angle (δ) from about 15° to about 75with respect to the moving direction of the filaments, and the intersection of said through hole being of oblong shape with an aspect ratio of at least 4:1, so as to spread the separated filaments along the wall of the divergent zone and arrange the filaments in a plane.

18. The spreader assembly according to claim 17, wherein said intersection of the through hole is of essentially the same width as the divergent zone.

19. The spreader assembly according to claim 16 wherein the through hole (242) connected to the inner channel is located at a point immediately upstream of the entrance end (231) of the divergent zone (23).

20. The spreader assembly according to claim 16 wherein the divergent zone has a pair of opposite walls closely spaced to each other and sidewalls perpendicular to the opposed walls, wherein the sidewalls diverge outwardly at an angle (α) of from about 10° to about 50°.

21. The spreader assembly according to claim 16 comprising at least two spreader units.

22. The spreader assembly according to claim 16 wherein the spreader unit comprises at least two passageways.

23. A process equipment suitable for reinforcing a substance with filaments, the equipment comprising a spreader assembly according to claim 16.

24. A use of the spreader assembly according to claim 16 for separating and spreading at least one fiber strand into a plurality of smaller strands and/or individual filaments.

25-26. (canceled)
